(19) United States
(12) Patent Application Publication
(10) Pub. No.: US 2026/0006626 A1
(43) Pub. Date: Jan. 1, 2026

(54) PRIORITIZATION BETWEEN SIDELINK REFERENCE SIGNALS AND SIDELINK DATA MESSAGES IN SIDELINK UNLICENSED DEPLOYMENTS

(71) Applicant: QUALCOMM Incorporated, San Diego, CA (US)

(72) Inventors: Siyi CHEN, Beijing (CN); Jing SUN, San Diego, CA (US); Xiaoxia ZHANG, San Diego, CA (US); Chih-Hao LIU, San Diego, CA (US); Giovanni CHISCI, San Diego, CA (US); Changlong XU, Beijing (CN); Shaozhen GUO, Beijing (CN); Luanxia YANG, Beijing (CN); Hao XU, Beijing (CN)

(21) Appl. No.: 19/140,960

(22) PCT Filed: Feb. 28, 2023
(86) PCT No.: PCT/CN2023/078632

§ 371 Date: Jun. 18, 2025

(51) Int. Cl. H04W 72/25; H04L 5/00

(52) U.S. Cl. CPC H04W 72/25; H04L 5/0048

(57) ABSTRACT

Methods, systems, and devices for wireless communications are described. Various aspects relate generally to signaling- or configuration-based mechanisms according to which user equipments (UEs) may prioritize between participating in communication of a sidelink reference signal or participating in communication of a sidelink data message in scenarios in which a candidate sidelink reference signal transmission occasion at least partially overlaps in time with the sidelink data message. Some aspects more specifically relate to prioritization techniques or transmission modes according to which a UE may select or otherwise ascertain a priority of a sidelink reference signal transmission or reception based on how recently a previous sidelink reference signal transmission or reception occurred. Further, some aspects relate to how a UE may transmit signaling in accordance with a decision at the UE to prioritize one of a sidelink reference signal or a sidelink data message.

### CROSS REFERENCE

The present Application is a 371 national phase filing of International PCT Application No. PCT/CN2023/078632 by CHEN et al., entitled “PRIORITIZATION BETWEEN SIDELINK REFERENCE SIGNALS AND SIDELINK DATA MESSAGES IN SIDELINK UNLICENSED DEPLOYMENTS,” filed Feb. 28, 2023, which is assigned to the assignee hereof, and which is expressly incorporated by reference in its entirety herein.

### FIELD OF TECHNOLOGY

The following relates to wireless communications, including prioritization between sidelink reference signals and sidelink data messages in sidelink unlicensed deployments.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support prioritization between sidelink reference signals and sidelink data messages in sidelink unlicensed deployments. For example, the described techniques provide for one or more signaling- or configuration-based (such as rule-based) mechanisms according to which a user equipment (UE) may select whether to prioritize sidelink reference signal communication or to prioritize sidelink data communication in scenarios in which a sidelink reference signal transmission occasion overlaps in time with sidelink data. In some implementations, such a sidelink reference signal may be a sidelink synchronization signal block (S-SSB).

A method for wireless communication at a UE is described. The method may include receiving control signaling indicating a set of candidate sidelink reference signal transmission occasions, the set of candidate sidelink reference signal transmission occasions being included within a sidelink resource pool available for sidelink data messages, participating in communication of sidelink control information that schedules a sidelink data message via a set of sidelink shared channel resources from the sidelink resource pool, and participating in communication of a sidelink reference signal, via a sidelink reference signal transmission occasion of the set of candidate sidelink reference signal transmission occasions that at least partially overlaps in time with the set of sidelink shared channel resources, the participation in the communication of the sidelink reference signal based on a comparison of a first priority value for the sidelink reference signal and a second priority value for the sidelink data message, where the first priority value for the sidelink reference signal is based on whether a sidelink reference signal transmission is performed within a threshold time period of the sidelink reference signal transmission occasion.

An apparatus for wireless communication at a UE is described. The apparatus may include a processor, memory coupled with the processor, and instructions stored in the memory. The instructions may be executable by the processor to cause the apparatus to receive control signaling indicating a set of candidate sidelink reference signal transmission occasions, the set of candidate sidelink reference signal transmission occasions being included within a sidelink resource pool available for sidelink data messages, participate in communication of sidelink control information that schedules a sidelink data message via a set of sidelink shared channel resources from the sidelink resource pool, and participate in communication of a sidelink reference signal, via a sidelink reference signal transmission occasion of the set of candidate sidelink reference signal transmission occasions that at least partially overlaps in time with the set of sidelink shared channel resources, the participation in the communication of the sidelink reference signal based on a comparison of a first priority value for the sidelink reference signal and a second priority value for the sidelink data message, where the first priority value for the sidelink reference signal is based on whether a sidelink reference signal transmission is performed within a threshold time period of the sidelink reference signal transmission occasion.

Another apparatus for wireless communication at a UE is described. The apparatus may include means for receiving control signaling indicating a set of candidate sidelink reference signal transmission occasions, the set of candidate sidelink reference signal transmission occasions being included within a sidelink resource pool available for sidelink data messages, means for participating in communication of sidelink control information that schedules a sidelink data message via a set of sidelink shared channel resources from the sidelink resource pool, and means for participating in communication of a sidelink reference signal, via a sidelink reference signal transmission occasion of the set of candidate sidelink reference signal transmission occasions that at least partially overlaps in time with the set of sidelink shared channel resources, the participation in the communication of the sidelink reference signal based on a comparison of a first priority value for the sidelink reference signal and a second priority value for the sidelink data message, where the first priority value for the sidelink reference signal is based on whether a sidelink reference signal transmission is performed within a threshold time period of the sidelink reference signal transmission occasion.

A non-transitory computer-readable medium storing code for wireless communication at a UE is described. The code may include instructions executable by a processor to receive control signaling indicating a set of candidate sidelink reference signal transmission occasions, the set of candidate sidelink reference signal transmission occasions being included within a sidelink resource pool available for sidelink data messages, participate in communication of sidelink control information that schedules a sidelink data message via a set of sidelink shared channel resources from the sidelink resource pool, and participate in communication of a sidelink reference signal, via a sidelink reference signal transmission occasion of the set of candidate sidelink reference signal transmission occasions that at least partially overlaps in time with the set of sidelink shared channel resources, the participation in the communication of the sidelink reference signal based on a comparison of a first priority value for the sidelink reference signal and a second priority value for the sidelink data message, where the first priority value for the sidelink reference signal is based on whether a sidelink reference signal transmission is performed within a threshold time period of the sidelink reference signal transmission occasion.

Some examples of the method, apparatuses, and non-transitory computer-readable medium described herein may further include operations, features, means, or instructions for dropping the sidelink data message based on the first priority value for the sidelink reference signal being greater than the second priority value for the sidelink data message.

Some examples of the method, apparatuses, and non-transitory computer-readable medium described herein may further include operations, features, means, or instructions for activating a mode according to which the UE participates in the communication of the sidelink reference signal based on an absence of sidelink reference signal transmissions or receptions within the threshold time period of the sidelink reference signal transmission occasion.

In some examples of the method, apparatuses, and non-transitory computer-readable medium described herein, participating in the communication of the sidelink control information that schedules the sidelink data message may include operations, features, means, or instructions for receiving information indicating that the set of sidelink shared channel resources may be for a retransmission of the sidelink data message, where participating in the communication of the sidelink reference signal via the sidelink reference signal transmission occasion may be based on a successful reception of an initial transmission of the sidelink data message.

Some examples of the method, apparatuses, and non-transitory computer-readable medium described herein may further include operations, features, means, or instructions for participating in the communication of the sidelink control information includes receiving the sidelink control information that schedules the sidelink data message via the set of sidelink shared channel resources and participating in the communication of the sidelink reference signal includes transmitting the sidelink reference signal via the sidelink reference signal transmission occasion and dropping a reception of the sidelink data message based on the comparison of the first priority value and the second priority value.

Some examples of the method, apparatuses, and non-transitory computer-readable medium described herein may further include operations, features, means, or instructions for selecting a highest priority value for the sidelink reference signal based on an absence of sidelink reference signal transmissions or receptions within the threshold time period of the sidelink reference signal transmission occasion, where participating in the communication of the sidelink reference signal may be based on selecting the highest priority value for the sidelink reference signal.

Some examples of the method, apparatuses, and non-transitory computer-readable medium described herein may further include operations, features, means, or instructions for participating in the communication of the sidelink control information includes transmitting the sidelink control information that schedules the sidelink data message via the set of sidelink shared channel resources and participating in the communication of the sidelink reference signal includes receiving the sidelink reference signal via the sidelink reference signal transmission occasion and dropping a transmission of the sidelink data message based on the comparison of the first priority value and the second priority value.

In some examples of the method, apparatuses, and non-transitory computer-readable medium described herein, the first priority value for the sidelink reference signal may be based on a priority level of a second UE that transmits the sidelink reference signal, the second UE being a synchronization reference UE.

Some examples of the method, apparatuses, and non-transitory computer-readable medium described herein may further include operations, features, means, or instructions for transmitting, via a groupcast sidelink control information message, an indication of an absence of sidelink reference signal transmissions by the UE within the threshold time period of the sidelink reference signal transmission occasion, where participating in the communication of the sidelink reference signal including transmitting the sidelink reference signal based on transmitting the indication of the absence of the sidelink reference signal transmissions by the UE within the threshold time period of the sidelink reference signal transmission occasion.

In some examples of the method, apparatuses, and non-transitory computer-readable medium described herein, the indication of the absence of the sidelink reference signal transmissions by the UE within the threshold time period of the sidelink reference signal transmission occasion indicates, to a second UE, a request for the second UE to cancel a transmission of the sidelink data message via the set of sidelink shared channel resources.

Some examples of the method, apparatuses, and non-transitory computer-readable medium described herein may further include operations, features, means, or instructions for receiving, from a second UE via a groupcast sidelink control information message, an indication of an absence of sidelink reference signal transmissions by the second UE within the threshold time period of the sidelink reference signal transmission occasion, where participating in the communication of the sidelink reference signal including receiving the sidelink reference signal based on receiving the indication of the absence of the sidelink reference signal transmissions by the second UE within the threshold time period of the sidelink reference signal transmission occasion.

In some examples of the method, apparatuses, and non-transitory computer-readable medium described herein, the groupcast sidelink control information message includes a destination identifier of the second UE and the UE identifies that the second UE may have not transmitted the sidelink reference signal transmissions within the threshold time period of the sidelink reference signal transmission occasion in accordance with the destination identifier and the indication of the absence included in the groupcast sidelink control information message.

Some examples of the method, apparatuses, and non-transitory computer-readable medium described herein may further include operations, features, means, or instructions for transmitting, based on the first priority value for the sidelink reference signal being greater than the second priority value for the sidelink data message, a sidelink feedback message responsive to the sidelink control information, where the sidelink feedback message indicates a conflict between the sidelink reference signal and the sidelink data message, and where participating in the communication of the sidelink reference signal includes transmitting the sidelink reference signal based on indicating the conflict via the sidelink feedback message.

In some examples of the method, apparatuses, and non-transitory computer-readable medium described herein, the UE receives the sidelink control information from a second UE and transmits the sidelink feedback message to the second UE and the sidelink feedback message indicating the conflict further indicates a request for the second UE to cancel a transmission of the sidelink data message via the set of sidelink shared channel resources.

Some examples of the method, apparatuses, and non-transitory computer-readable medium described herein may further include operations, features, means, or instructions for sidelink feedback messages indicating conflicts between sidelink reference signals and sidelink data messages may be transmitted via a same set of sidelink feedback channel symbols, a same periodicity, and a same cyclic shift as sidelink feedback messages indicating feedback associated with sidelink data messages.

Some examples of the method, apparatuses, and non-transitory computer-readable medium described herein may further include operations, features, means, or instructions for sidelink feedback messages indicating conflicts between sidelink reference signals and sidelink data messages may be transmitted via a first set of physical resource blocks and sidelink feedback messages indicating feedback associated with sidelink data messages may be transmitted via a second set of physical resource blocks.

In some examples of the method, apparatuses, and non-transitory computer-readable medium described herein, the sidelink feedback message may be transmitted via a sidelink feedback channel resource and the sidelink feedback channel resource may be associated with an index that may be based on a source identifier of a second UE from which the UE receives the sidelink control information.

In some examples of the method, apparatuses, and non-transitory computer-readable medium described herein, participating in the communication of the sidelink control information may include operations, features, means, or instructions for receiving the sidelink control information that schedules the sidelink data message via the set of sidelink shared channel resources, where the sidelink control information includes information indicative of the second priority value of the sidelink data message.

In some examples of the method, apparatuses, and non-transitory computer-readable medium described herein, participating in the communication of the sidelink control information may include operations, features, means, or instructions for selecting a starting offset, from a set of starting offsets, for the sidelink reference signal relative to a starting point of the sidelink reference signal transmission occasion in accordance with the first priority value for the sidelink reference signal and applying a cyclic prefix extension to the sidelink reference signal, where a length of the cyclic prefix extension may be based on the starting offset.

In some examples of the method, apparatuses, and non-transitory computer-readable medium described herein, a respective starting offset of the set of starting offsets corresponds to a respective priority value of a set of priority values and the first priority value may be associated with the starting offset and the second priority value may be associated with a second starting offset.

In some examples of the method, apparatuses, and non-transitory computer-readable medium described herein, the sidelink reference signal includes an S-SSB.

A method for wireless communication at a UE is described. The method may include receiving control signaling indicating a set of candidate sidelink reference signal transmission occasions, the set of candidate sidelink reference signal transmission occasions being included within a sidelink resource pool available for sidelink data messages, participating in communication of sidelink control information that schedules a sidelink data message via a set of sidelink shared channel resources from the sidelink resource pool, where the set of sidelink shared channel resources at least partially overlaps in time with a sidelink reference signal transmission occasion of the set of candidate sidelink reference signal transmission occasions, and participating in communication of the sidelink data message, via the set of sidelink shared channel resources, based on a comparison of a first priority value for a sidelink reference signal and a second priority value for the sidelink data message, where the first priority value for the sidelink reference signal is based on whether a sidelink reference signal transmission is performed within a threshold time period of the sidelink reference signal transmission occasion.

An apparatus for wireless communication at a UE is described. The apparatus may include a processor, memory coupled with the processor, and instructions stored in the memory. The instructions may be executable by the processor to cause the apparatus to receive control signaling indicating a set of candidate sidelink reference signal transmission occasions, the set of candidate sidelink reference signal transmission occasions being included within a sidelink resource pool available for sidelink data messages, participate in communication of sidelink control information that schedules a sidelink data message via a set of sidelink shared channel resources from the sidelink resource pool, where the set of sidelink shared channel resources at least partially overlaps in time with a sidelink reference signal transmission occasion of the set of candidate sidelink reference signal transmission occasions, and participate in communication of the sidelink data message, via the set of sidelink shared channel resources, based on a comparison of a first priority value for a sidelink reference signal and a second priority value for the sidelink data message, where the first priority value for the sidelink reference signal is based on whether a sidelink reference signal transmission is performed within a threshold time period of the sidelink reference signal transmission occasion.

Another apparatus for wireless communication at a UE is described. The apparatus may include means for receiving control signaling indicating a set of candidate sidelink reference signal transmission occasions, the set of candidate sidelink reference signal transmission occasions being included within a sidelink resource pool available for sidelink data messages, means for participating in communication of sidelink control information that schedules a sidelink data message via a set of sidelink shared channel resources from the sidelink resource pool, where the set of sidelink shared channel resources at least partially overlaps in time with a sidelink reference signal transmission occasion of the set of candidate sidelink reference signal transmission occasions, and means for participating in communication of the sidelink data message, via the set of sidelink shared channel resources, based on a comparison of a first priority value for a sidelink reference signal and a second priority value for the sidelink data message, where the first priority value for the sidelink reference signal is based on whether a sidelink reference signal transmission is performed within a threshold time period of the sidelink reference signal transmission occasion.

A non-transitory computer-readable medium storing code for wireless communication at a UE is described. The code may include instructions executable by a processor to receive control signaling indicating a set of candidate sidelink reference signal transmission occasions, the set of candidate sidelink reference signal transmission occasions being included within a sidelink resource pool available for sidelink data messages, participate in communication of sidelink control information that schedules a sidelink data message via a set of sidelink shared channel resources from the sidelink resource pool, where the set of sidelink shared channel resources at least partially overlaps in time with a sidelink reference signal transmission occasion of the set of candidate sidelink reference signal transmission occasions, and participate in communication of the sidelink data message, via the set of sidelink shared channel resources, based on a comparison of a first priority value for a sidelink reference signal and a second priority value for the sidelink data message, where the first priority value for the sidelink reference signal is based on whether a sidelink reference signal transmission is performed within a threshold time period of the sidelink reference signal transmission occasion.

Some examples of the method, apparatuses, and non-transitory computer-readable medium described herein may further include operations, features, means, or instructions for dropping the sidelink reference signal based on the first priority value for the sidelink reference signal being lower than the second priority value for the sidelink data message.

Some examples of the method, apparatuses, and non-transitory computer-readable medium described herein may further include operations, features, means, or instructions for selecting a lowest priority value for the sidelink reference signal in accordance with a presence of sidelink reference signal transmissions or receptions within the threshold time period of the sidelink reference signal transmission occasion, where participating in the communication of the sidelink data message may be based on selecting the lowest priority value for the sidelink reference signal.

In some examples of the method, apparatuses, and non-transitory computer-readable medium described herein, participating in the communication of the sidelink control information that schedules the sidelink data message may include operations, features, means, or instructions for receiving information indicating that the set of sidelink shared channel resources may be for a retransmission of the sidelink data message, where participating in the communication of the sidelink data message via the set of sidelink shared channel resources may be based on an unsuccessful reception of an initial transmission of the sidelink data message.

Some examples of the method, apparatuses, and non-transitory computer-readable medium described herein may further include operations, features, means, or instructions for participating in the communication of the sidelink control information includes receiving the sidelink control information that schedules the sidelink data message via the set of sidelink shared channel resources and participating in the communication of the sidelink data message includes receiving the sidelink data message via the set of sidelink shared channel resources and dropping a transmission of the sidelink reference signal based on the comparison of the first priority value and the second priority value.

Some examples of the method, apparatuses, and non-transitory computer-readable medium described herein may further include operations, features, means, or instructions for participating in the communication of the sidelink control information includes transmitting the sidelink control information that schedules the sidelink data message via the set of sidelink shared channel resources and participating in the communication of the sidelink reference signal includes transmitting the sidelink data message via the set of sidelink shared channel resources and dropping a reception of the sidelink reference signal based on the comparison of the first priority value and the second priority value.

In some examples of the method, apparatuses, and non-transitory computer-readable medium described herein, the first priority value for the sidelink reference signal may be based on a priority level of a second UE that transmits the sidelink reference signal, the second UE being a synchronization reference UE.

Some examples of the method, apparatuses, and non-transitory computer-readable medium described herein may further include operations, features, means, or instructions for selecting a starting offset, from a set of starting offsets, for the sidelink data message relative to a starting point of the sidelink reference signal transmission occasion in accordance with the second priority value for the sidelink data message and applying a cyclic prefix extension to the sidelink data message, where a length of the cyclic prefix extension may be based on the starting offset.

In some examples of the method, apparatuses, and non-transitory computer-readable medium described herein, a respective starting offset of the set of starting offsets corresponds to a respective priority value of a set of priority values and the second priority value may be associated with the starting offset and the first priority value may be associated with a second starting offset.

In some examples of the method, apparatuses, and non-transitory computer-readable medium described herein, the sidelink reference signal includes an S-SSB.

### BRIEF DESCRIPTION OF THE DRAWINGS

FIG. 1 illustrates an example of a wireless communications system that supports prioritization between sidelink reference signals and sidelink data messages in sidelink unlicensed deployments in accordance with one or more aspects of the present disclosure.

FIG. 2 illustrates an example of a signaling diagram that supports prioritization between sidelink reference signals and sidelink data messages in sidelink unlicensed deployments in accordance with one or more aspects of the present disclosure.

FIGS. 3-7 illustrate examples of communication timelines that support prioritization between sidelink reference signals and sidelink data messages in sidelink unlicensed deployments in accordance with one or more aspects of the present disclosure.

FIGS. 8 and 9 illustrate examples of process flows that support prioritization between sidelink reference signals and sidelink data messages in sidelink unlicensed deployments in accordance with one or more aspects of the present disclosure.

FIGS. 10 and 11 illustrate block diagrams of devices that support prioritization between sidelink reference signals and sidelink data messages in sidelink unlicensed deployments in accordance with one or more aspects of the present disclosure.

FIG. 12 illustrates a block diagram of a communications manager that supports prioritization between sidelink reference signals and sidelink data messages in sidelink unlicensed deployments in accordance with one or more aspects of the present disclosure.

FIG. 13 illustrates a diagram of a system including a device that supports prioritization between sidelink reference signals and sidelink data messages in sidelink unlicensed deployments in accordance with one or more aspects of the present disclosure.

FIGS. 14 and 15 illustrate flowcharts showing methods that support prioritization between sidelink reference signals and sidelink data messages in sidelink unlicensed deployments in accordance with one or more aspects of the present disclosure.

### DETAILED DESCRIPTION

In some wireless communication systems, two or more user equipment (UEs) may communicate with each other via one or more sidelinks. For example, a first UE may communicate with (e.g., transmit to or receive from, or both) a second UE via a sidelink. In such examples, the first UE and the second UE may communicate via sidelink resources from a sidelink resource pool (e.g., a sidelink data resource pool), which may include physical sidelink shared channel (PSSCH) resources. In some deployments, one or both of the first UE and the second UE may receive control signaling indicating a set of candidate sidelink reference signal transmission occasions, which may be part of the sidelink resource pool. In some examples, the set of candidate sidelink reference signal transmission occasions may include candidate sidelink synchronization signal block (S-SSB) transmission occasions via which S-SSBs may be transmitted. If the set of candidate sidelink reference signal transmission occasions are included within the resource pool, scenarios may arise in which a candidate sidelink reference signal transmission occasion at least partially overlaps in time with a scheduled sidelink data message.

If a UE at which such a conflict arises is a half-duplex UE, the UE may be able to either participate in communication of the sidelink reference signal or participate in communication of the sidelink data message, but not both. In some systems, however, UEs may lack a configured or mutually understood mechanism according to which UEs can select whether to participate in the communication of the sidelink reference signal or the sidelink data message. In such systems, data rates or link qualities, or both, may be adversely impacted as a result of potentially unsuitable, incorrect, or irregular prioritization decisions at a UE. For example, if a UE incorrectly prioritizes an S-SSB over a sidelink data message, data rates may be unnecessarily hindered. Alternatively, if a UE incorrectly prioritizes a sidelink data message over an S-SSB, a link quality may deteriorate, which may impart a cost that relatively higher data rates may not offset.

In some implementations, various aspects relate generally to signaling- or configuration-based mechanisms according to which UEs may prioritize between participating in communication of a sidelink reference signal (e.g., an S-SSB) or participating in communication of a sidelink data message (e.g., via a set of PSSCH resources) in scenarios in which a candidate sidelink reference signal transmission occasion at least partially overlaps in time with the sidelink data message. Some aspects more specifically relate to prioritization techniques or transmission modes according to which a UE may select or otherwise ascertain a priority of a sidelink reference signal transmission or reception based on how recently a previous sidelink reference signal transmission or reception occurred. In some examples, for instance, a UE may enter a transmission mode associated with sidelink reference signal transmissions or may select a highest priority value for a sidelink reference signal if the UE has not transmitted or received a sidelink reference signal within a threshold amount of time. In some other examples, a UE may select a lowest priority value for a sidelink reference signal if the UE has transmitted or received a sidelink reference signal within a threshold amount of time. Further, some aspects relate to how a UE may transmit signaling associated with a decision at the UE to prioritize one of a sidelink reference signal or a sidelink data message. Such signaling may include groupcast sidelink control information (SCI) or a sidelink feedback message and the UE may transmit such signaling to explicitly or implicitly request a second UE to refrain from transmitting a sidelink data message or to refrain from monitoring for a sidelink data message (if, for example, the sidelink reference signal is prioritized over the sidelink data message).

Particular aspects of the subject matter described in this disclosure can be implemented to realize one or more of the following potential advantages. In some examples, by supporting prioritization mechanisms associated with sidelink reference signals and sidelink data messages based on a recency of a previous sidelink reference signal transmission or reception, the described techniques can be used to balance link quality maintenance and sidelink data rates. For example, if a UE has not transmitted or received a sidelink reference signal within a threshold amount of time, the UE may identify, determine, or otherwise ascertain, in accordance with a signaled or configured mechanism, that transmission or reception of a sidelink reference signal during a current candidate transmission occasion is a high priority for continued link maintenance. Alternatively, if a UE has transmitted or received a sidelink reference signal within a threshold amount of time, the UE may identify, determine, or otherwise ascertain, in accordance with a signaled or configured mechanism, that transmission or reception of a sidelink data message during a current candidate transmission occasion may provide higher data rates without compromising link quality maintenance. As such, UEs may experience higher and more predictable reliability, which may in turn facilitate higher data rates, greater capacity, and greater spectral efficiency. Further, in accordance with signaling explicitly or implicitly indicating a prioritization between a sidelink reference signal and a sidelink data message, UEs may achieve greater power savings, lower power consumption, and longer battery life by selectively performing sidelink data message transmissions based on expected or indicated prioritization decisions.

Aspects of the disclosure are initially described in the context of wireless communications systems. Aspects of the disclosure are additionally illustrated by and described with reference to a signaling diagram, communication timelines, and process flows. Aspects of the disclosure are further illustrated by and described with reference to apparatus diagrams, system diagrams, and flowcharts that relate to prioritization between sidelink reference signals and sidelink data messages in sidelink unlicensed deployments.

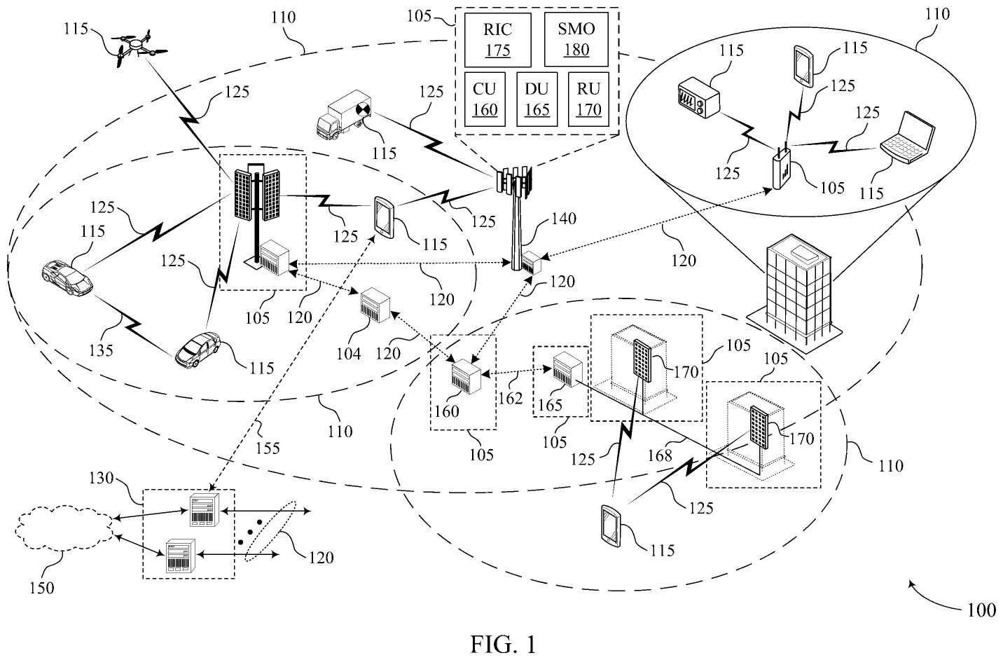

FIG. 1 illustrates an example of a wireless communications system 100 that supports prioritization between sidelink reference signals and sidelink data messages in sidelink unlicensed deployments in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support prioritization between sidelink reference signals and sidelink data messages in sidelink unlicensed deployments as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting.” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrow band communications), or a combination of these techniques. For example, some UEs 115 may be configured for operation using a narrow band protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some implementations, UEs 115 may support one or more signaling- or configuration-based mechanisms according to which the UEs 115 may prioritize between participating in communication of a sidelink reference signal (e.g., an S-SSB) or participating in communication of a sidelink data message (e.g., via a set of PSSCH resources) in scenarios in which a candidate sidelink reference signal transmission occasion at least partially overlaps in time with the sidelink data message. For example, a UE 115 may support or operate in accordance with prioritization techniques or transmission modes according to which the UE 115 may select or otherwise ascertain a priority of a sidelink reference signal transmission or reception based on how recently a previous sidelink reference signal transmission or reception occurred.

In some examples, for instance, a UE 115 may enter a transmission mode associated with sidelink reference signal transmissions or may select a highest priority value for a sidelink reference signal if the UE 115 has not transmitted or received a sidelink reference signal within a threshold amount of time. In some other examples, a UE 115 may select a lowest priority value for a sidelink reference signal if the UE 115 has transmitted or received a sidelink reference signal within a threshold amount of time. Further, some aspects relate to how a UE 115 may transmit signaling in accordance with a decision at the UE 115 to prioritize one of a sidelink reference signal or a sidelink data message. Such signaling may include broadcast SCI or a sidelink feedback message. In some examples, a UE 115 may transmit such signaling to explicitly or implicitly request a second UE 115 to refrain from transmitting a sidelink data message or to refrain from monitoring for a sidelink data message (if, for example, the sidelink reference signal is prioritized over the sidelink data message).

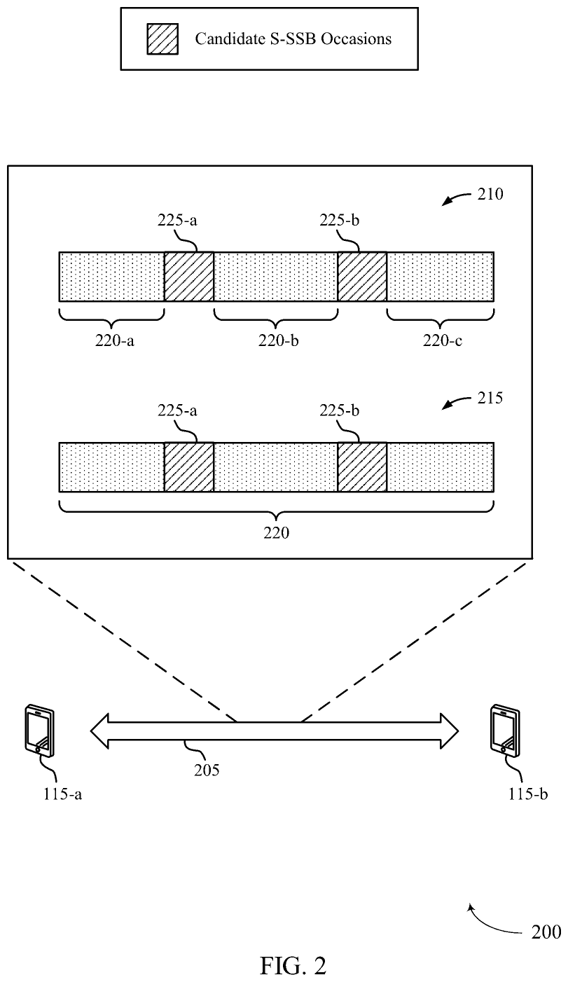

FIG. 2 illustrates an example of a signaling diagram 200 that supports prioritization between sidelink reference signals and sidelink data messages in sidelink unlicensed deployments in accordance with one or more aspects of the present disclosure. The signaling diagram may implement or be implemented to realize or facilitate aspects of the wireless communications system 100. For example, the signaling diagram 200 illustrates communication between a UE 115-a and a UE 115-b, which may each be examples of corresponding devices as illustrated and described herein, including UEs 115 illustrated by and described with reference to FIG. 1.

The UE 115-a and the UE 115-b may communicate via a sidelink 205 and, in some systems, the resources available for use by the UE 115-a and the UE 115-b may vary in accordance with whether a set of candidate sidelink reference signal transmission occasions (e.g., candidate S-SSB occasions) are included in a sidelink resource pool or are excluded from the sidelink resource pool. For example, and as illustrated by a resource diagram 210, a set of candidate S-SSB occasions may be excluded from a sidelink resource pool available to the UE 115-a and the UE 115-b. As such, the UE 115-a and the UE 115-b may transmit or receive sidelink data messages via a resource pool segment 220-a, a resource pool segment 220-b, and a resource pool segment 220-c and may refrain from transmitting or receiving sidelink data messages via resources associated with a candidate S-SSB occasion 225-a and a candidate S-SSB occasion 225-b. Alternatively, and as illustrated by a resource diagram 215, a set of candidate S-SSB occasions may be included in a sidelink resource pool available to the UE 115-a and the UE 115-b. As such, the UE 115-a and the UE 115-b may transmit or receive sidelink data messages via a resource pool 220, which may include resources associated with the candidate S-SSB occasion 225-a and the candidate S-SSB occasion 225-b.

In some aspects, the candidate S-SSB occasion 225-a and the candidate S-SSB occasion 225-b may be examples of or may otherwise be referred to as additional or supplemental candidate S-SSB occasions. For example, one or both of the UE 115-a and the UE 115-b may support (such as transmit or receive) a first type of candidate S-SSB occasions and a second type (e.g., an additional or supplemental type) of candidate S-SSB occasions, where the candidate S-SSB occasion 225-a and the candidate S-SSB occasion 225-b may be examples of the second type of candidate S-SSB occasions. Regarding such additional candidate S-SSB occasions, the UE 115-a and the UE 115-b may support (such as operate in accordance with) one or more of various rules according to which S-SSBs are selectively transmitted via the second type of candidate S-SSB occasions.

In an example, within a same S-SSB period, a UE 115 (such as the UE 115-a or the UE 115-b, or both) may attempt to transmit via all or some of the second type of candidate S-SSB occasion(s) if the UE 115 fails to transmit via one or more candidate S-SSB occasions of the first type. Alternatively, within a same S-SSB period, a UE 115 (such as the UE 115-a or the UE 115-b, or both) may attempt to transmit on all of the second type of candidate S-SSB occasion(s) regardless of whether the UE 115 transmitted on one or more candidate S-SSB occasions of the first type. Alternatively, within a same S-SSB period, a UE 115 (such as the UE 115-a or the UE 115-b, or both) may attempt to transmit via all or some of the second type of candidate S-SSB occasion(s) regardless of whether the UE 115 transmitted on one or more candidate S-SSB occasions of the first type. Alternatively, upon a listen-before-talk (LBT) failure on a candidate S-SSB occasion, a UE 115 (such as the UE 115-a or the UE 115-b, or both) may attempt to transmit via a subsequent additional (e.g., second type of) candidate S-SSB occasion if, within a period, an S-SSB transmission has not been transmitted in any prior occasions.

If such additional (e.g., second type of) candidate S-SSB occasions are excluded from a sidelink resource pool, as illustrated by the resource diagram 210, a sidelink transmission within a channel occupancy time (COT) may be interrupted frequently (e.g., due to the sidelink resource pool being split into the resource pool segment 220-a, the resource pool segment 220-b, and the resource pool segment 220-c). As such, the UE 115-a and the UE 115-b may experience lower channel access success rates and lower throughput. Accordingly, to achieve greater, more complete, or more efficient resource utilization, the UE 115-a and the UE 115-b may communicate in accordance with the resource diagram 215 according to which additional S-SSB candidate occasions (e.g., the candidate S-SSB occasion 225-a and the candidate S-SSB occasion 225-b) are included in the resource pool 220.

If the additional S-SSB candidate occasions are included in a sidelink resource pool, mechanisms associated with handling or addressing half-duplex constraints may be a significant aspect in terms of facilitating greater adoption of sidelink and facilitating compatibility between various devices, as well as efficiently balancing link quality maintenance and throughput. For example, how a half-duplex UE 115 handles situations in which the half-duplex UE 115 is scheduled, indicated, or configured to transmit sidelink data and receive an S-SSB simultaneously, or receive sidelink data and transmit an S-SSB simultaneously, may largely impact link quality maintenance or throughput, or both.

Further, overlapping sidelink data communication and S-SSB communication at a half-duplex UE 115 may also implicate performance at other UEs 115, such as a UE 115 scheduled to transmit to the half-duplex UE 115 via either or both of a physical sidelink control channel (PSCCH) or a PSSCH. For example, without a configured mechanism, a transmitting UE 115 that transmits via a PSCCH or PSSCH to a half-duplex UE 115 may be unaware of whether the half-duplex UE 115 will transmit an S-SSB in the same slot as the PSCCH or PSSCH communication. Specifically, if the transmitting UE 115 transmits via a PSCCH or PSSCH but the half-duplex UE 115 does not receive the PSCCH or PSSCH due to a simultaneous S-SSB transmission by the half-duplex UE 115, the transmitting UE 115 may waste battery power or communication resources, or both, and may unnecessarily contribute interference to the system.

Accordingly, in some implementations, UEs 115 (e.g., including the UE 115-a and the UE 115-b) may support one or more signaling- or configuration-based mechanisms according to which the UEs 115 can prioritize between participating in communication of an S-SSB or participating in communication of a sidelink data message (e.g., a PSSCH message) in scenarios in which a candidate S-SSB occasion at least partially overlaps in time with the sidelink data message. For example, a UE 115 (such as the UE 115-a or the UE 115-b) may support or operate in accordance with prioritization techniques or transmission modes according to which the UE 115 may select or otherwise ascertain a priority of an S-SSB transmission or reception based on how recently a previous S-SSB transmission or reception occurred.

An S-SSB may include a sidelink primary synchronization signal (S-PSS), a sidelink secondary synchronization signal (S-SSS), and a physical sidelink broadcast channel (PSBCH). Accordingly, S-SSB detection may be understood as or associated with an energy of an S-PSS or an S-SSS being higher than a threshold energy level or decoding a PSBCH successfully, or both. In other words, a UE 115 may detect that an S-SSB is received if the UE 115 measures an S-PSS or S-SSS with an energy level greater than the threshold energy level or if the UE 115 successfully decodes (and extracts information from) a PSBCH, or if both.

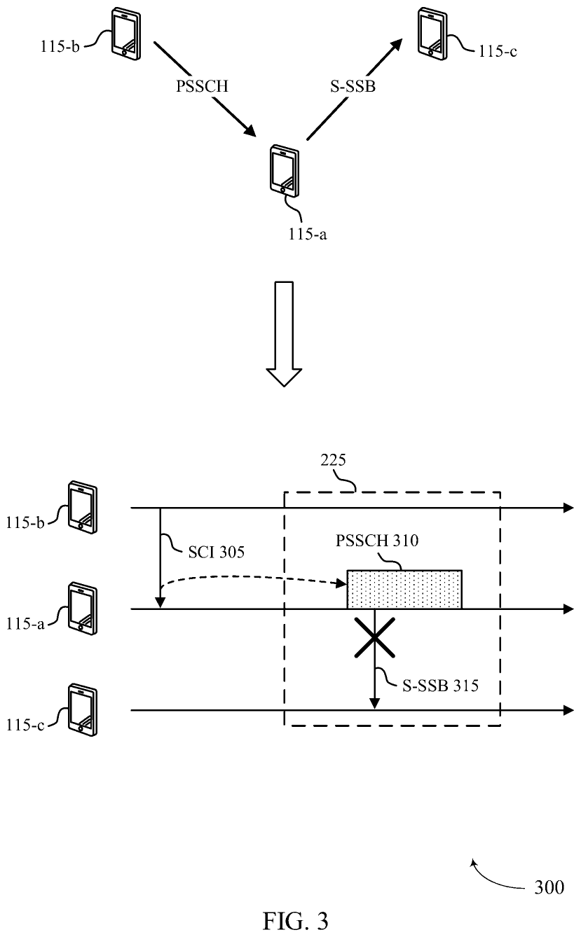

FIG. 3 illustrates an example of a communication timeline 300 that supports prioritization between sidelink reference signals and sidelink data messages in sidelink unlicensed deployments in accordance with one or more aspects of the present disclosure. The communication timeline 300 may implement or be implemented to realize or facilitate aspects of the wireless communications system 100 or the signaling diagram 200. For example, the communication timeline 300 illustrates communication between a UE 115-a, a UE 115-b, and a UE 115-c, which may each be examples of corresponding devices as illustrated by and described with reference to FIGS. 1 and 2.

The UE 115-a may be an example of otherwise function in a half-duplex mode (e.g., in accordance with a device capability or a power save mode) and may be scheduled, indicated, or configured to receive a sidelink data message from the UE 115-b over a time period (e.g., a set of slots or symbols) that at least partially overlaps in time with a candidate S-SSB occasion 225 via which the UE 115-a may perform an S-SSB transmission to (at least) the UE 115-c. For example, the UE 115-a may receive an SCI message 305 from the UE 115-b scheduling a PSSCH 310 (via which a sidelink data message may be transmitted) during the candidate S-SSB occasion 225 via which the UE 115-a may also have the option (e.g., in accordance with scheduling, an indication, or a configuration) to transmit an S-SSB 315.

In some implementations, the UE 115-a may prioritize the S-SSB transmission if, within a threshold time period (e.g., with an S-SSB period), the UE 115-a has not performed an S-SSB transmission in any prior occasions (e.g., any prior candidate S-SSB occasions). In such implementations, if the UE 115-a has not transmitted an S-SSB within a set of previous candidate S-SSB occasions within a threshold time period, the UE 115-a may activate or enter a transmission mode according to which the UE 115-a transmits S-SSBs. For example, such a transmission mode may be associated with a constraint at the UE 115-a to transmit an S-SSB (and drop any other conflicting communications). Accordingly, if the UE 115-a has not transmitted an S-SSB within a set of previous candidate S-SSB occasions within a threshold time period, the UE 115-a may drop PSSCH reception and instead prioritize the transmission of the S-SSB 315.

Alternatively, if the UE 115-a has transmitted an S-SSB via at least one candidate S-SSB occasion (or via at least a threshold quantity of candidate S-SSB occasions) within the threshold time period of the candidate S-SSB occasion 225, the UE 115-a may set a priority value (e.g., an S-SSB priority or a sidelink priority) of the S-SSB 315 to a lowest priority value or the UE 115-a may refer to a priority value for the S-SSB 315 as indicated or configured by control signaling (e.g., RRC signaling, a MAC control element (MAC-CE), or downlink control information (DCI)). As such, the UE 115-a may know, select, or determine a priority value for the S-SSB 315, either in accordance with a selection at the UE 115-a or in accordance with received signaling (from another UE 115 or a network entity 105). Accordingly, if the UE 115-a has transmitted S-SSB in previous candidate S-SSB occasions within the threshold time period (e.g., within an S-SSB period) and a priority value (e.g., a sidelink priority value) of the reserved PSSCH 310 is higher than a priority value for the S-SSB 315, the UE 115-a may drop the S-SSB 315 to receive the PSSCH 310 (as illustrated in the example of FIG. 3). In some aspects, the S-SSB 315 may be a padding S-SSB the UE 115-a may be scheduled or indicated to transmit to maintain a COT of the UE 115-a.

Additionally, or alternatively, the UE 115-a may select whether to prioritize the PSSCH 310 or the S-SSB 315 based on a previous PSSCH decoding result at the UE 115-a. For example, if the SCI message 305 reserves the PSSCH 310 for a retransmission of a sidelink data message, and if the UE 115-a successfully received and decoded the initial PSSCH (e.g., the initial instance or transmission of the sidelink data message), the UE 115-a may drop the later reserved slot for retransmission reception and instead select to transmit the S-SSB 315. Alternatively, if the UE 115-a failed to successfully receive and decode the initial PSSCH (e.g., the initial instance or transmission of the sidelink data message), the UE 115-a may drop the S-SSB 315 and instead attempt to decode the PSSCH 310 reserved for the retransmission.

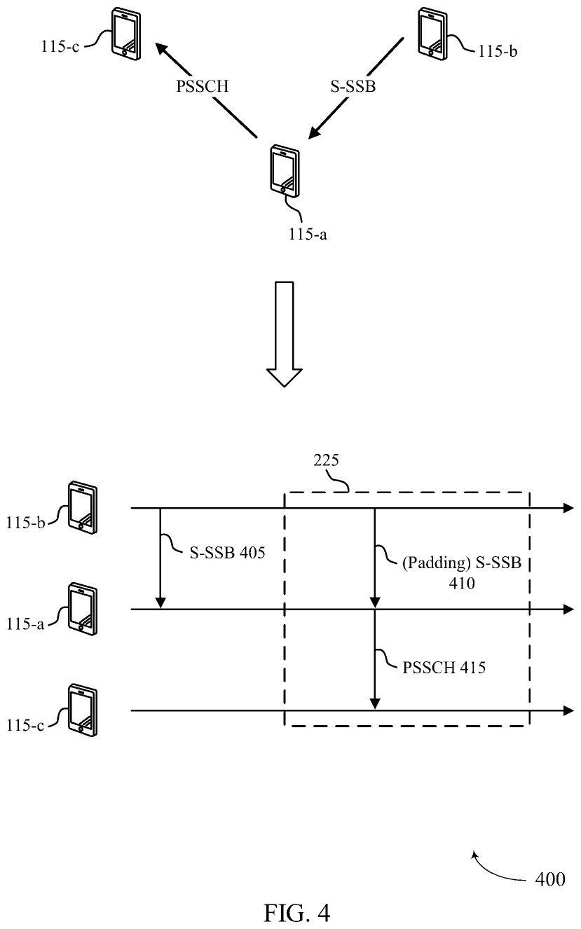

FIG. 4 illustrates an example of a communication timeline 400 that supports prioritization between sidelink reference signals and sidelink data messages in sidelink unlicensed deployments in accordance with one or more aspects of the present disclosure. The communication timeline 400 may implement or be implemented to realize or facilitate aspects of the wireless communications system 100 or the signaling diagram 200. For example, the communication timeline 400 illustrates communication between a UE 115-a, a UE 115-b, and a UE 115-c, which may each be examples of corresponding devices as illustrated by and described with reference to FIGS. 1 and 2.

The UE 115-a may be an example of otherwise function in a half-duplex mode (e.g., in accordance with a device capability or a power save mode) and may be scheduled, indicated, or configured to receive an S-SSB 410 from the UE 115-b via a candidate S-SSB occasion 225 that at least partially overlaps in time with a time period (e.g., a set of slots or symbols) via which the UE 115-a may be scheduled, indicated, or configured to transmit a sidelink data message via a PSSCH 415 to the UE 115-c. In some implementations, the UE 115-a may prioritize S-SSB reception if an S-SSB 405 has not been received in any prior candidate S-SSB occasions within a threshold time period (e.g., within an S-SSB period) of the candidate S-SSB occasion 225 and may prioritize PSSCH reception otherwise.

For example, if the UE 115-a has not received an S-SSB 405 via any prior candidate S-SSB occasions within a threshold time period (e.g., an S-SSB period) of the candidate S-SSB occasion 225, the UE 115-a may set a priority value (e.g., a sidelink priority value) of the S-SSB 410 to a highest priority value. In other words, because the UE 115-a may be aware or identify the priority value of the S-SSB 410 based on S-SSB detection within the threshold time period, the UE 115-a may drop the PSSCH 415 (e.g., may drop PSSCH transmission) and receive the S-SSB 410 if an S-SSB 405 has not been received in any prior candidate S-SSB occasions within the threshold time period.

Alternatively, if the UE 115-a has received an S-SSB 405 via at least one candidate S-SSB occasion (or via a threshold quantity of candidate S-SSB occasions) within a threshold time period (e.g., an S-SSB period) of the candidate S-SSB occasion 225, the UE 115-a may set a priority value of the S-SSB 410 to a lowest priority value or the UE 115-a may refer to a priority value for the S-SSB 410 as indicated or configured by control signaling. As such, the UE 115-a may know, select, or determine a priority value for the S-SSB 410, either in accordance with a selection at the UE 115-a or in accordance with received signaling (from another UE 115 or a network entity 105). Accordingly, if the UE 115-a has received an S-SSB 405 in previous candidate S-SSB occasions within the threshold time period (e.g., within an S-SSB period) and a priority value of the PSSCH 415 is higher than a priority value for the S-SSB 410, the UE 115-a may drop reception of the S-SSB 410 to transmit the PSSCH 415.

In some implementations, a priority of the S-SSB 410 may be associated with a priority of the UE 115-b that transmits the S-SSB 410. For example, if the UE 115-b is a relatively high priority synchronization reference (SyncRef) UE 115, the UE 115-a may refrain from updating the UE 115-b (e.g., the SyncRef UE 115) within a time period. In such examples, the UE 115-a may set a priority of the S-SSB 410 to a relatively low priority value. Alternatively, if the UE 115-b is a relatively low priority SyncRef UE 115, the UE 115-a may have a higher likelihood of trying to update the SyncRef UE 115 at a later time and may set a priority of the S-SSB 410 to a relatively higher priority value accordingly.

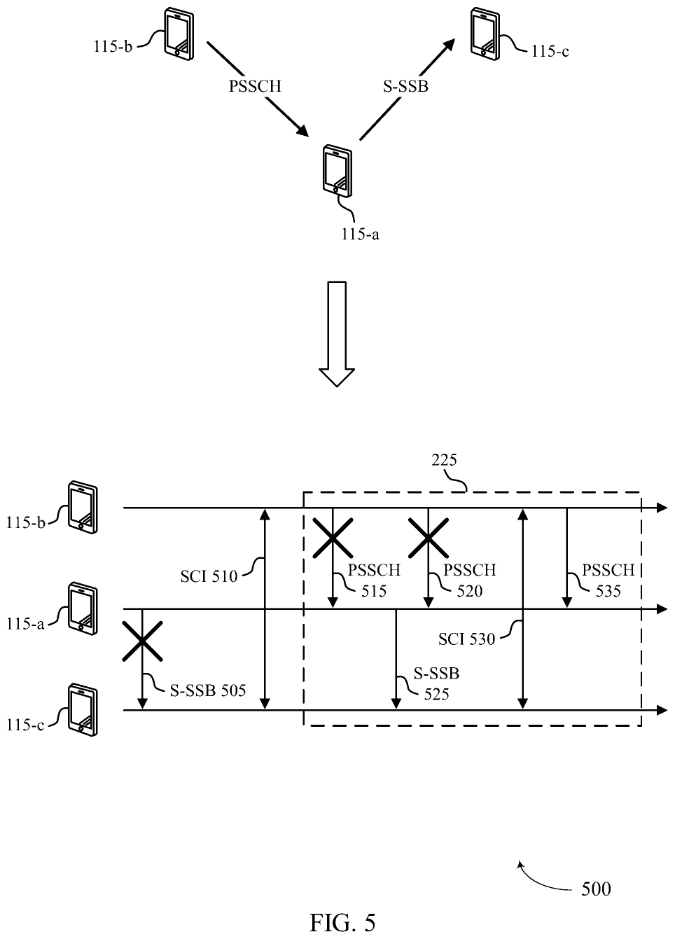

FIG. 5 illustrates an example of a communication timeline 500 that supports prioritization between sidelink reference signals and sidelink data messages in sidelink unlicensed deployments in accordance with one or more aspects of the present disclosure. The communication timeline 500 may implement or be implemented to realize or facilitate aspects of the wireless communications system 100, the signaling diagram 200, the communication timeline 300, or the communication timeline 400. For example, the communication timeline 500 illustrates communication between a UE 115-a, a UE 115-b, and a UE 115-c, which may each be examples of corresponding devices as illustrated by and described with reference to FIGS. 1 through 4.

In some implementations, UEs 115 may support an indication in SCI to indicate whether a UE 115 has transmitted an S-SSB within a threshold time period of a candidate S-SSB occasion 225. In such implementations, a UE 115 that receives SCI indicating an absence of S-SSB transmissions within the threshold time period of the candidate S-SSB occasion 225 and that is scheduled to transmit a sidelink data message during the candidate S-SSB occasion 225 may cancel the sidelink data message transmission based on the indication in the SCI. For example, if the UE 115-a does not transmit an S-SSB 505 within a threshold time period of the candidate S-SSB occasion 225, the UE 115-a may transmit an SCI message 510 (to the UE 115-b and the UE 115-c) indicating the absence of the S-SSB 505 within the threshold time period of the candidate S-SSB occasion 225.

Accordingly, the UE 115-b may cancel a PSSCH 515 and a PSSCH 520 (to save battery power, communication resources, and reduce system interference) and the UE 115-a may set a priority value for an S-SSB 525 to a relatively high value (e.g., a highest value). The UE 115-a may transmit the S-SSB 525 to the UE 115-c based on setting the priority value for the S-SSB 525 to the relatively high value and, after transmitting the S-SSB 525, may transmit an SCI message 530 indicating that the UE 115-a has transmitted an S-SSB (including at least the S-SSB 525) within a threshold time period.

The UE 115-b may receive the SCI message 530 and may refrain from cancelling a PSSCH 535 accordingly. Instead, the UE 115-b may transmit a sidelink data message via the PSSCH 535 to the UE 115-a and may expect the UE 115-a to monitor for the PSSCH 535 based on the transmission of the S-SSB 525 within the threshold time period. In other words, if the UE 115-a transmits an indication (via the SCI message 510) that the UE 115-a has not transmitted an S-SSB 505 within a threshold time period, the UE 115-b may refrain from performing a PSSCH transmission to the UE 115-a in additional (e.g., second type of) candidate S-SSB occasions before the UE 115-b receives a new or updated indication that indicates the UE 115-a has transmitted an S-SSB 525 within a threshold time period.

In some implementations, because the UE 115-a may transmit such an indication of a presence or absence of recent S-SSB transmissions to a set of (multiple) UEs 115 and because it may be unnecessary for such an indication to be included in some transmissions, the UE 115 may transmit the indication via a groupcast SCI message. For example, the SCI message 510 and the SCI message 530 may be examples of groupcast SCI messages and the UE 115-a may transmit the SCI message 510 and the SCI message 530 when a cast type is associated with a groupcast option, such as groupcast option 2 (e.g., associated with a cast type identifier of 01) in second stage SCI part A (SCI2-A).

Additionally, or alternatively, the SCI message 510 and the SCI message 530 may be examples of later stage SCI messages, such as third stage SCI (e.g., SCI3 or SCI-3). The UE 115-b and the UE 115-c may identify the UE 115-a (e.g., the transmitter of the SCI message 510 and the SCI message 530) via a destination identifier. As such, UEs 115 may be aware and keep track of which other UEs 115 have or have not transmitted an S-SSB within a threshold time period.

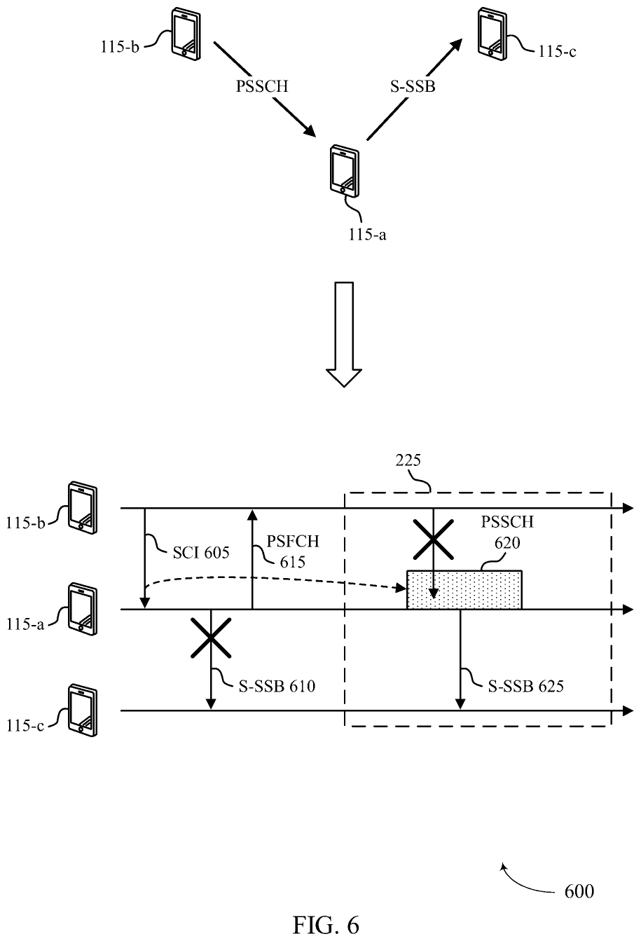

FIG. 6 illustrates an example of a communication timeline 600 that supports prioritization between sidelink reference signals and sidelink data messages in sidelink unlicensed deployments in accordance with one or more aspects of the present disclosure. The communication timeline 600 may implement or be implemented to realize or facilitate aspects of the wireless communications system 100, the signaling diagram 200, the communication timeline 300, or the communication timeline 400. For example, the communication timeline 600 illustrates communication between a UE 115-a, a UE 115-b, and a UE 115-c, which may each be examples of corresponding devices as illustrated by and described with reference to FIGS. 1 through 4.

In some implementations, UEs 115 may support an indication in a sidelink feedback message (e.g., a PSFCH) to indicate a conflict between a sidelink data message (e.g., transmitted via a PSSCH) and an S-SSB if a priority value of the sidelink data message is lower than a priority value of the S-SSB. A UE 115 that is scheduled to transmit the sidelink data message may cancel a transmission of the sidelink data message based on the indication. For example, if the UE 115-a receives an SCI message 605 from the UE 115-b scheduling a PSSCH 620 during a candidate S-SSB occasion 225 and if the UE 115-a has not transmitted an S-SSB 610 within a threshold time period of the candidate S-SSB occasion 225, the UE 115-a may transmit an indication of the conflict to the UE 115-b via a PSFCH 615. As such, the UE 115-b may cancel the PSSCH 620. Likewise, the UE 115-a may drop reception of the PSSCH 620 and instead transmit an S-SSB 625 during the candidate S-SSB occasion 225.

In some aspects, the UE 115-a may identify, obtain, select, extract, or otherwise determine a priority value for the PSSCH 620 from reservation information (e.g., from the SCI message 605). Accordingly, if the reserved resource overlaps with the additional (e.g., second type of) candidate S-SSB occasion 225 and the priority value of the PSSCH 620 is lower than a priority value of the S-SSB 625, the UE 115-a may transmit a conflict indication to the UE 115-b via the PSFCH 615. In some implementations, UE 115-b may not perform transmission to the UE 115-a via the reserved resources accordingly.

The UE 115-a may transmit the indication of the conflict via the PSFCH 615 in accordance with one or more of various mechanisms. In some implementations, for example, the UE 115-a may use a same set of PSFCH symbols, a same periodicity, and a same quantity of cyclic shift (CS) pairs for the conflict indication as the UE 115-a may otherwise use for transmitting feedback. Additionally, or alternatively, PSFCH resources for conflict indication and PSFCH resources for feedback may be configured (e.g., via previous signaling, pre-loaded in a memory, etc.) on different physical resource blocks (PRBs). For example, the UE 115-a may transmit conflict indications via a first set of PSFCH PRBs and may transmit feedback via a second set of PSFCH PRBs. As such, the PSFCH resources used for conflict indications and the PSFCH resources used for feedback may be frequency division multiplexed with each other. Additionally, or alternatively, the UE 115-a may determine (e.g., identify, calculate, select, or otherwise ascertain) an index of a PSFCH resource for a PSFCH transmission based on a source identifier of the UE 115-b that transmits the SCI message 605.

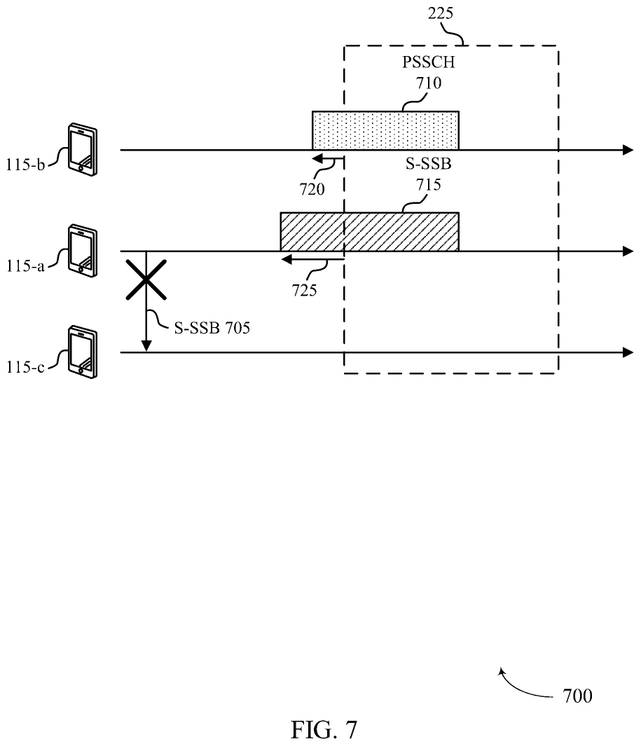

FIG. 7 illustrates an example of a communication timeline 700 that supports prioritization between sidelink reference signals and sidelink data messages in sidelink unlicensed deployments in accordance with one or more aspects of the present disclosure. The communication timeline 700 may implement or be implemented to realize or facilitate aspects of the wireless communications system 100, the signaling diagram 200, the communication timeline 300, the communication timeline 400, the communication timeline 500, or the communication timeline 600. For example, the communication timeline 700 illustrates communication between a UE 115-a, a UE 115-b, and a UE 115-c, which may each be examples of corresponding devices as illustrated by and described with reference to FIGS. 1 through 6.

In some implementations, a UE 115 may apply a cyclic prefix (CP) extension to one or both of S-SSB transmissions or PSSCH transmissions in accordance with relatively sidelink traffic priorities. For example, UEs 115 may apply a CP extension to S-SSB transmissions and PSSCH transmissions if an S-SSB and a PSSCH are transmitted in a same RB set. In some aspects, a UE 115 may support multiple starting points associated with sidelink traffic priority, where different starting points are associated with different sidelink traffic priorities. For example, a relatively higher priority transmission may be configured with an offset value with a relatively earlier starting point as compared to a relatively lower priority transmission, such that relatively higher priority transmissions may block relatively lower priority transmissions. A UE 115 may fill a time domain gap between a starting point (based on an offset value) and a start of the actual transmission (e.g., a useful waveform transmission) with a CP extension.

For example, and as illustrated in FIG. 7, the UE 115-a may not transmit an S-SSB 705 within a threshold time period of the candidate S-SSB occasion 225 and may set a priority value for an S-SSB 715 within the candidate S-SSB occasion 225 to a relatively high value (e.g., a highest value). As such, a priority value for the S-SSB 715 may be higher than a priority value for a PSSCH 710 scheduled during the candidate S-SSB occasion 225. The UE 115-b may select, from a set of available options or in accordance with a signaled or configured value), a starting offset 720 for the PSSCH 710. The UE 115-a may select, from a set of available options or in accordance with a signaled or configured value, a starting offset 725 for the S-SSB 715. In accordance with the S-SSB 715 having a relatively higher priority than the PSSCH 710, the starting offset 725 may be associated with a relatively earlier start time than the starting offset 720. As such, the S-SSB 715 may block the PSSCH 710. For example, a CP extension on the S-SSB 715 may cause the UE 115-b to fail a channel access procedure (e.g., an LBT procedure) and refrain from transmitting the PSSCH 710.

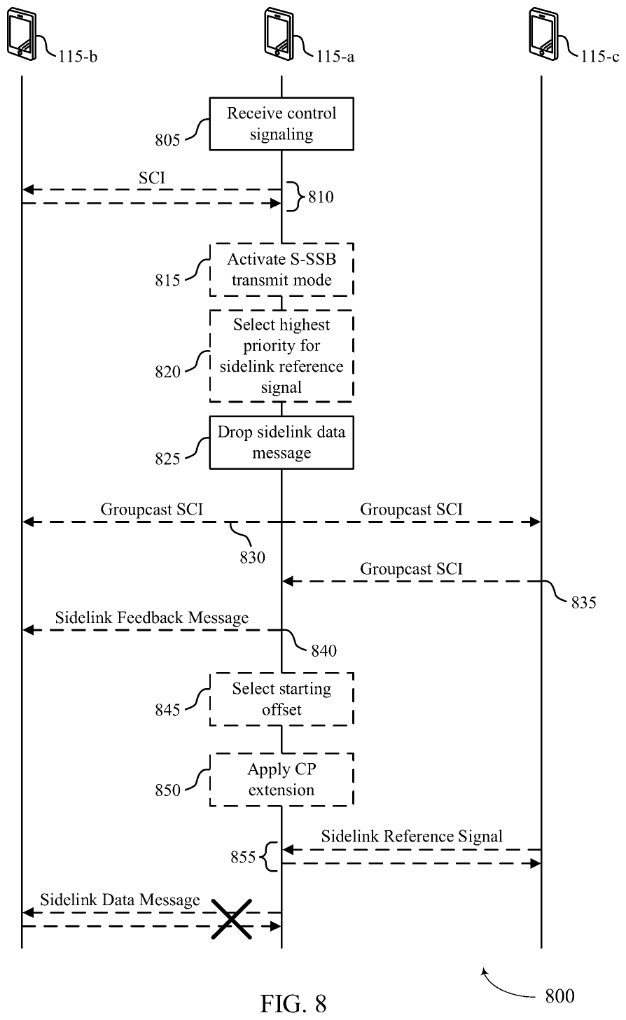

FIG. 8 illustrates an example of a process flow 800 that supports prioritization between sidelink reference signals and sidelink data messages in sidelink unlicensed deployments in accordance with one or more aspects of the present disclosure. The process flow 800 may implement or be implemented to realize or facilitate aspects of the wireless communications system 100, the signaling diagram 200, the communication timeline 300, the communication timeline 400, the communication timeline 500, the communication timeline 600, or the communication timeline 700. For example, the process flow 800 illustrates communication between a UE 115-a, a UE 115-b, and a UE 115-c, which may each be examples of corresponding devices as illustrated by and described with reference to FIGS. 1 through 7.

In the following description of the process flow 800, the operations may be performed (such as reported or provided) in a different order than the order shown, or the operations performed by the example devices may be performed in different orders or at different times. Some operations also may be left out of the process flow 800, or other operations may be added to the process flow 800. Further, although some operations or signaling may be shown to occur at different times for discussion purposes, these operations may actually occur at the same time.

At 805, the UE 115-a may receive control signaling indicating a set of candidate sidelink reference signal (e.g., S-SSB) transmission occasions. In some examples, the set of candidate sidelink reference signal transmission occasions may be included within a sidelink resource pool available for sidelink data (e.g., PSCCH and PSSCH) communication between the UE 115-a, the UE 115-b, and the UE 115-c. The UE 115-a may receive the control signaling from another UE 115 (such as one or both of the UE 115-b or the UE 115-c) or from a network entity 105.

At 810, the UE 115-a and the UE 115-b may participate in communication of (e.g., transmit or receive) SCI that schedules a sidelink data message via a set of sidelink shared channel (e.g., PSSCH) resources from the sidelink resource pool. In some implementations, the UE 115-a may transmit the SCI message to schedule or reserve a PSSCH for a sidelink data transmission from the UE 115-a to the UE 115-b. In some other implementations, the UE 115-b may transmit the SCI message to schedule or reserve a PSSCH for a sidelink data transmission from the UE 115-b to the UE 115-a. In some aspects, the SCI message may include information indicative of a priority value for a scheduled sidelink data message. In some aspects, the SCI message may indicate that the reserved PSSCH is for a retransmission of a sidelink data message. In some scenarios, the SCI may schedule the sidelink data message for a set of PSSCH resources that at least partially overlap in time with a candidate sidelink reference signal transmission occasion of the set of sidelink reference signal transmission occasions.

At 815, the UE 115-a may activate a mode (e.g., a transmission mode) according to which the UE 115-a participates in the communication of the sidelink reference signal based on an absence of sidelink reference signal transmissions or receptions within a threshold time period of the sidelink reference signal transmission occasion.

At 820, the UE 115-a may select a highest priority value for the sidelink reference signal based on an absence of sidelink reference signal transmissions or receptions within the threshold time period of the sidelink reference signal transmission occasion.

At 825, the UE 115-a may drop the sidelink data message (e.g., may drop reception of the sidelink data message) based on a first priority for the sidelink reference signal being greater than a second priority for the sidelink data message. In some implementations, the first priority value may be greater than the second priority value in accordance with the activated mode at the UE 115-a. Additionally, or alternatively, the first priority value may be greater than the second priority value in accordance with the UE 115-a selecting the highest priority value for the sidelink reference signal.

At 830, the UE 115-a may transmit a groupcast SCI message including an indication of an absence of sidelink reference signal transmissions by the UE 115-a within the threshold time period of the sidelink reference signal transmission occasion. In some implementations, the UE 115-a may transmit the groupcast SCI message including the indication of the absence of sidelink reference signal transmissions by the UE 115-a within the threshold time period of the sidelink reference signal transmission occasion to inform other UEs 115 (e.g., including the UE 115-b) that the UE 115-a is likely to prioritize a sidelink reference signal transmission over any other conflicting signaling during the sidelink reference signal transmission occasion. In some implementations, the indication of the absence may explicitly or implicitly indicate, to at least the UE 115-b, a request to cancel a sidelink data transmission scheduled during the sidelink reference signal transmission occasion.

At 835, the UE 115-a may receive, from the UE 115-c, a groupcast SCI message including an indication of an absence of sidelink reference signal transmissions by the UE 115-c within the threshold time period of the sidelink reference signal transmission occasion. In some implementations, the groupcast SCI message may include a destination identifier of the UE 115-c and the UE 115-a may identify that the UE 115-c has not transmitted sidelink reference signal transmissions within the threshold time period of the sidelink reference signal transmission occasion in accordance with receiving the groupcast SCI message. As such, the UE 115-a may prioritize S-SSB reception from the UE 115-c.

At 840, the UE 115-a may transmit, to the UE 115-b, a sidelink feedback message (e.g., via a PSFCH) responsive to the SCI communicated (e.g., received) at 810. In some implementations, the sidelink feedback message may indicate a conflict between the sidelink data message and the sidelink reference signal. In such implementations, the indication of the conflict may explicitly or implicitly indicate a request for the UE 115-b to cancel a transmission of the sidelink data message during the sidelink reference signal transmission occasion.

In some examples, the UE 115-a may transmit the sidelink feedback message via (e.g., using) a same set of sidelink feedback channel symbols, a same periodicity, and a same CS as sidelink feedback messages indicating or providing feedback associated with sidelink data messages. Additionally, or alternatively, the UE 115-a may transmit the sidelink feedback message via a first set of PRBs different from a second set of PRBs that the UE 115-a may use for sidelink feedback messages indicating or providing feedback associated with sidelink data messages. Additionally, or alternatively, the UE 115-a may select a sidelink feedback channel resource associated with an index that is based on a source identifier of the UE 115-b from which the UE 115-a receives the SCI at 810.

At 845, the UE 115-a may select a starting offset, from a set of starting offsets, for the sidelink reference signal. The starting offset may be relative to a starting point of the sidelink reference signal transmission occasion. In some implementations, the UE 115-a may select the starting offset based on the first priority value for the sidelink reference signal. For example, a respective starting offset of the set of starting offsets may correspond to a respective priority value of a set of priority values.

At 850, the UE 115-a may add a CP extension to the sidelink reference signal based on the starting offset. For example, a length or duration of the CP extension may be based on (e.g., equal to) the starting offset.

At 855, the UE 115-a may participate in communication of (e.g., transmit or receive) the sidelink reference signal during the sidelink reference signal transmission occasion. In some implementations, the UE 115-a may participate in the communication of the sidelink reference signal based on a comparison of the first priority value for the sidelink reference signal and the second priority for the sidelink data message, where the first priority value for the sidelink reference signal is based on whether a sidelink reference signal transmission is performed (by the UE 115-a or the UE 115-c) within a threshold time period of the sidelink reference signal transmission occasion. In some implementations, the UE 115-a may transmit the sidelink reference signal to the UE 115-c. In some other implementations, the UE 115-a may receive the sidelink reference signal from the UE 115-c.

Likewise, and in accordance with dropping the sidelink data message, the UE 115-a may refrain from participating in any communication of (e.g., transmitting or monitoring for) the sidelink data message. Additionally, in some implementations, the

UE 115-b may also refrain from participating in any communication of (e.g., transmitting or monitoring for) the sidelink data message.

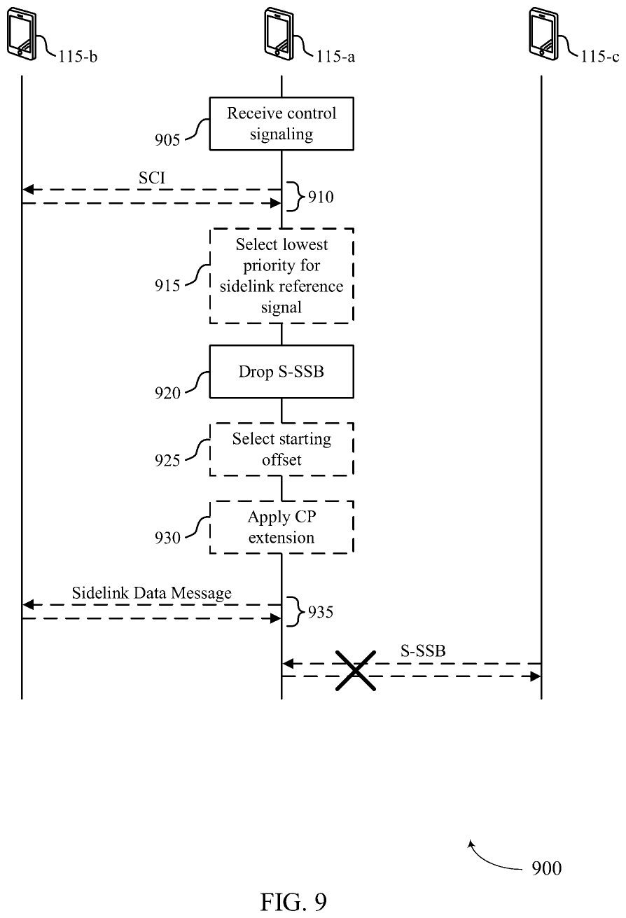

FIG. 9 illustrates an example of a process flow 900 that supports prioritization between sidelink reference signals and sidelink data messages in sidelink unlicensed deployments in accordance with one or more aspects of the present disclosure. The process flow 900 may implement or be implemented to realize or facilitate aspects of the wireless communications system 100, the signaling diagram 200, the communication timeline 300, the communication timeline 400, the communication timeline 500, the communication timeline 600, or the communication timeline 700. For example, the process flow 900 illustrates communication between a UE 115-a, a UE 115-b, and a UE 115-c, which may each be examples of corresponding devices as illustrated by and described with reference to FIGS. 1 through 7.

In the following description of the process flow 900, the operations may be performed (such as reported or provided) in a different order than the order shown, or the operations performed by the example devices may be performed in different orders or at different times. Some operations also may be left out of the process flow 900, or other operations may be added to the process flow 900. Further, although some operations or signaling may be shown to occur at different times for discussion purposes, these operations may actually occur at the same time.

At 905, the UE 115-a may receive control signaling indicating a set of candidate sidelink reference signal (e.g., S-SSB) transmission occasions. In some examples, the set of candidate sidelink reference signal transmission occasions may be included within a sidelink resource pool available for sidelink data (e.g., PSCCH and PSSCH) communication between the UE 115-a, the UE 115-b, and the UE 115-c. The UE 115-a may receive the control signaling from another UE 115 (such as one or both of the UE 115-b or the UE 115-c) or from a network entity 105.

At 910, the UE 115-a and the UE 115-b may participate in communication of (e.g., transmit or receive) SCI that schedules a sidelink data message via a set of sidelink shared channel (e.g., PSSCH) resources from the sidelink resource pool. In some implementations, the UE 115-a may transmit the SCI message to schedule or reserve a PSSCH for a sidelink data transmission from the UE 115-a to the UE 115-b. In some other implementations, the UE 115-b may transmit the SCI message to schedule or reserve a PSSCH for a sidelink data transmission from the UE 115-b to the UE 115-a. In some aspects, the SCI message may include information indicative of a priority value for a scheduled sidelink data message. In some aspects, the SCI message may indicate that the reserved PSSCH is for a retransmission of a sidelink data message. In some scenarios, the SCI may schedule the sidelink data message for a set of PSSCH resources that at least partially overlap in time with a candidate sidelink reference signal transmission occasion of the set of sidelink reference signal transmission occasions.

At 915, the UE 115-a may select a lowest priority value for a sidelink reference signal in accordance with a presence of sidelink reference signal transmissions or receptions within the threshold time period of the sidelink reference signal transmission occasion.

At 920, the UE 115-a may drop (transmission or reception of) the sidelink reference signal based on a first priority value for the sidelink reference signal being lower than a second priority value for the sidelink data message. In some implementations, the UE 115-a may drop the sidelink reference signal based on selecting the lowest priority value for the sidelink reference signal.

At 925, the UE 115-a may select a starting offset, from a set of starting offsets, for the sidelink data message. The starting offset may be relative to a starting point of the sidelink reference signal transmission occasion. In some implementations, the UE 115-a may select the starting offset based on the second priority value for the sidelink data message. For example, a respective starting offset of the set of starting offsets may correspond to a respective priority value of a set of priority values.

At 930, the UE 115-a may add a CP extension to the sidelink data message based on the starting offset. For example, a length or duration of the CP extension may be based on (e.g., equal to) the starting offset.

At 935, the UE 115-a may participate in communication of (e.g., transmit or receive) the sidelink data message via the set of sidelink shared channel resources. In some implementations, the UE 115-a may participate in the communication of the sidelink data message based on a comparison of the first priority value for the sidelink reference signal and the second priority for the sidelink data message, where the first priority value for the sidelink reference signal is based on whether a sidelink reference signal transmission is performed (by the UE 115-a or the UE 115-c) within a threshold time period of the sidelink reference signal transmission occasion. In some implementations, the UE 115-a may transmit the sidelink data message to the UE 115-b. In some other implementations, the UE 115-a may receive the sidelink data message from the UE 115-b.

Likewise, and in accordance with dropping the sidelink reference signal, the UE 115-a may refrain from participating in any communication of (e.g., transmitting, monitoring for, or measuring) the sidelink reference signal. Additionally, in some implementations, the UE 115-c may also refrain from participating in any communication of (e.g., transmitting, monitoring for, or measuring) the sidelink reference signal.

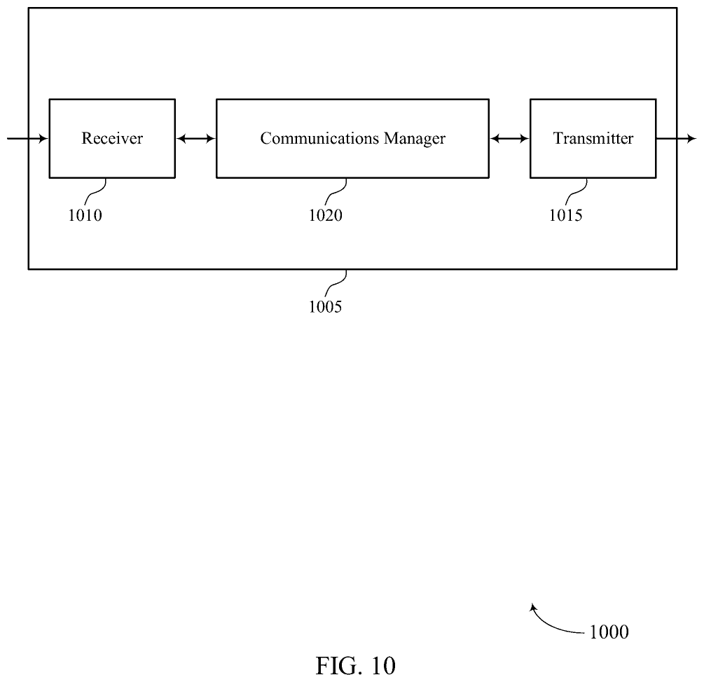

FIG. 10 illustrates a block diagram 1000 of a device 1005 that supports prioritization between sidelink reference signals and sidelink data messages in sidelink unlicensed deployments in accordance with one or more aspects of the present disclosure. The device 1005 may be an example of aspects of a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of prioritization between sidelink reference signals and sidelink data messages in sidelink unlicensed deployments as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a UE in accordance with examples as disclosed herein. For example, the communications manager 1020 may be configured as or otherwise support a means for receiving control signaling indicating a set of candidate sidelink reference signal transmission occasions, the set of candidate sidelink reference signal transmission occasions being included within a sidelink resource pool available for sidelink data messages. The communications manager 1020 may be configured as or otherwise support a means for participating in communication of sidelink control information that schedules a sidelink data message via a set of sidelink shared channel resources from the sidelink resource pool. The communications manager 1020 may be configured as or otherwise support a means for participating in communication of a sidelink reference signal, via a sidelink reference signal transmission occasion of the set of candidate sidelink reference signal transmission occasions that at least partially overlaps in time with the set of sidelink shared channel resources, the participation in the communication of the sidelink reference signal based on a comparison of a first priority value for the sidelink reference signal and a second priority value for the sidelink data message, where the first priority value for the sidelink reference signal is based on whether a sidelink reference signal transmission is performed within a threshold time period of the sidelink reference signal transmission occasion.

Additionally, or alternatively, the communications manager 1020 may support wireless communication at a UE in accordance with examples as disclosed herein. For example, the communications manager 1020 may be configured as or otherwise support a means for receiving control signaling indicating a set of candidate sidelink reference signal transmission occasions, the set of candidate sidelink reference signal transmission occasions being included within a sidelink resource pool available for sidelink data messages. The communications manager 1020 may be configured as or otherwise support a means for participating in communication of sidelink control information that schedules a sidelink data message via a set of sidelink shared channel resources from the sidelink resource pool, where the set of sidelink shared channel resources at least partially overlaps in time with a sidelink reference signal transmission occasion of the set of candidate sidelink reference signal transmission occasions. The communications manager 1020 may be configured as or otherwise support a means for participating in communication of the sidelink data message, via the set of sidelink shared channel resources, based on a comparison of a first priority value for a sidelink reference signal and a second priority value for the sidelink data message, where the first priority value for the sidelink reference signal is based on whether a sidelink reference signal transmission is performed within a threshold time period of the sidelink reference signal transmission occasion.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced processing, reduced power consumption, and more efficient utilization of communication resources.

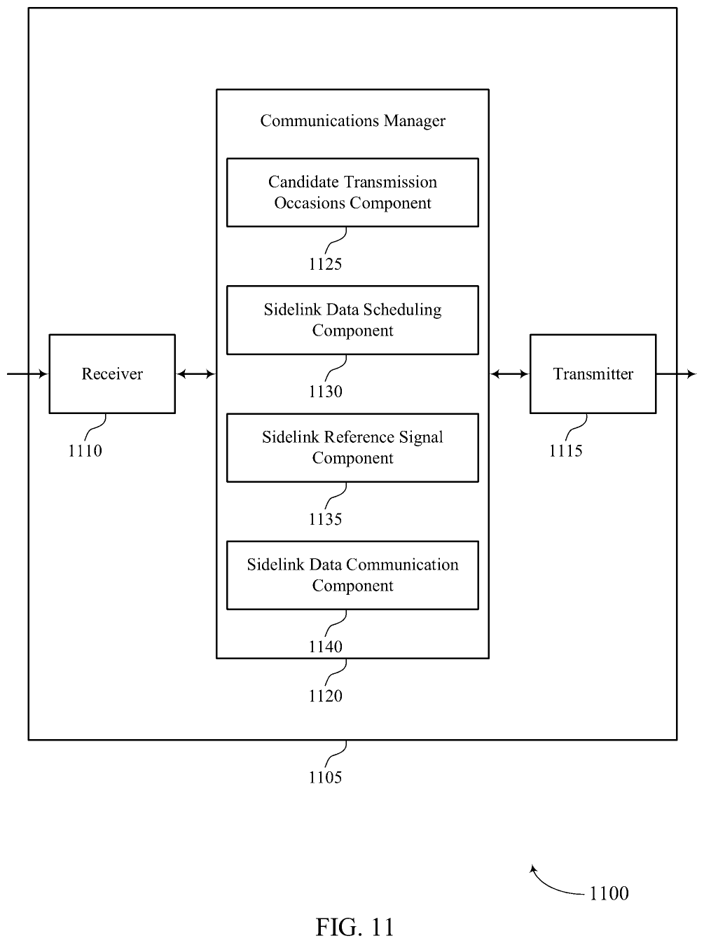

FIG. 11 illustrates a block diagram 1100 of a device 1105 that supports prioritization between sidelink reference signals and sidelink data messages in sidelink unlicensed deployments in accordance with one or more aspects of the present disclosure. The device 1105 may be an example of aspects of a device 1005 or a UE 115 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of prioritization between sidelink reference signals and sidelink data messages in sidelink unlicensed deployments as described herein. For example, the communications manager 1120 may include a candidate transmission occasions component 1125, a sidelink data scheduling component 1130, a sidelink reference signal component 1135, a sidelink data communication component 1140, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a UE in accordance with examples as disclosed herein. The candidate transmission occasions component 1125 may be configured as or otherwise support a means for receiving control signaling indicating a set of candidate sidelink reference signal transmission occasions, the set of candidate sidelink reference signal transmission occasions being included within a sidelink resource pool available for sidelink data messages. The sidelink data scheduling component 1130 may be configured as or otherwise support a means for participating in communication of sidelink control information that schedules a sidelink data message via a set of sidelink shared channel resources from the sidelink resource pool. The sidelink reference signal component 1135 may be configured as or otherwise support a means for participating in communication of a sidelink reference signal, via a sidelink reference signal transmission occasion of the set of candidate sidelink reference signal transmission occasions that at least partially overlaps in time with the set of sidelink shared channel resources, the participation in the communication of the sidelink reference signal based on a comparison of a first priority value for the sidelink reference signal and a second priority value for the sidelink data message, where the first priority value for the sidelink reference signal is based on whether a sidelink reference signal transmission is performed within a threshold time period of the sidelink reference signal transmission occasion.

Additionally, or alternatively, the communications manager 1120 may support wireless communication at a UE in accordance with examples as disclosed herein. The candidate transmission occasions component 1125 may be configured as or otherwise support a means for receiving control signaling indicating a set of candidate sidelink reference signal transmission occasions, the set of candidate sidelink reference signal transmission occasions being included within a sidelink resource pool available for sidelink data messages. The sidelink data scheduling component 1130 may be configured as or otherwise support a means for participating in communication of sidelink control information that schedules a sidelink data message via a set of sidelink shared channel resources from the sidelink resource pool, where the set of sidelink shared channel resources at least partially overlaps in time with a sidelink reference signal transmission occasion of the set of candidate sidelink reference signal transmission occasions. The sidelink data communication component 1140 may be configured as or otherwise support a means for participating in communication of the sidelink data message, via the set of sidelink shared channel resources, based on a comparison of a first priority value for a sidelink reference signal and a second priority value for the sidelink data message, where the first priority value for the sidelink reference signal is based on whether a sidelink reference signal transmission is performed within a threshold time period of the sidelink reference signal transmission occasion.

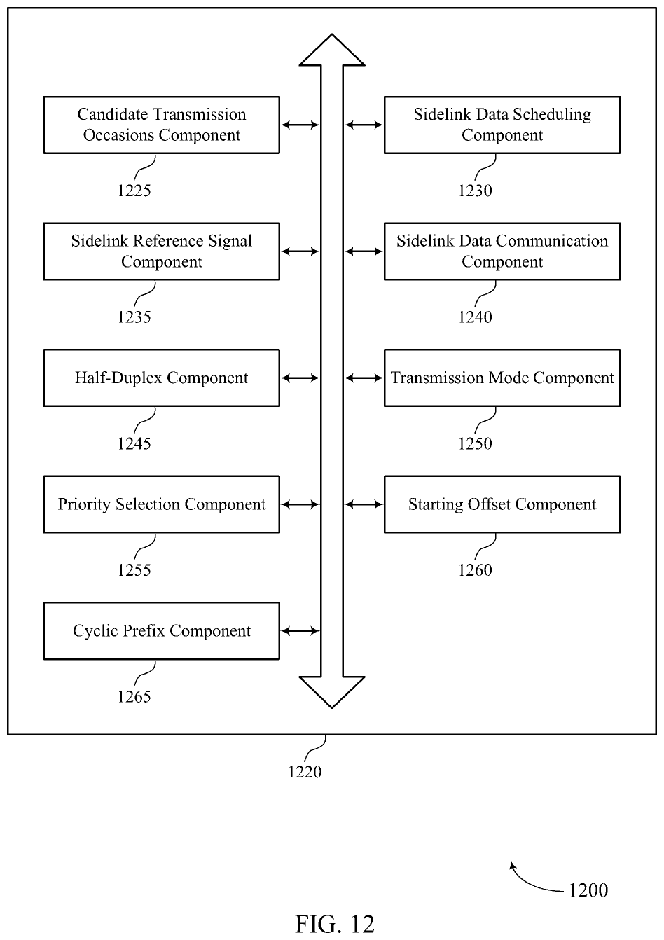

FIG. 12 illustrates a block diagram 1200 of a communications manager 1220 that supports prioritization between sidelink reference signals and sidelink data messages in sidelink unlicensed deployments in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of prioritization between sidelink reference signals and sidelink data messages in sidelink unlicensed deployments as described herein. For example, the communications manager 1220 may include a candidate transmission occasions component 1225, a sidelink data scheduling component 1230, a sidelink reference signal component 1235, a sidelink data communication component 1240, a half-duplex component 1245, a transmission mode component 1250, a priority selection component 1255, a starting offset component 1260, a cyclic prefix component 1265, or any combination thereof. Each of these components may communicate, directly or indirectly, with one another (e.g., via one or more buses).

The communications manager 1220 may support wireless communication at a UE in accordance with examples as disclosed herein. The candidate transmission occasions component 1225 may be configured as or otherwise support a means for receiving control signaling indicating a set of candidate sidelink reference signal transmission occasions, the set of candidate sidelink reference signal transmission occasions being included within a sidelink resource pool available for sidelink data messages. The sidelink data scheduling component 1230 may be configured as or otherwise support a means for participating in communication of sidelink control information that schedules a sidelink data message via a set of sidelink shared channel resources from the sidelink resource pool. The sidelink reference signal component 1235 may be configured as or otherwise support a means for participating in communication of a sidelink reference signal, via a sidelink reference signal transmission occasion of the set of candidate sidelink reference signal transmission occasions that at least partially overlaps in time with the set of sidelink shared channel resources, the participation in the communication of the sidelink reference signal based on a comparison of a first priority value for the sidelink reference signal and a second priority value for the sidelink data message, where the first priority value for the sidelink reference signal is based on whether a sidelink reference signal transmission is performed within a threshold time period of the sidelink reference signal transmission occasion.

In some examples, the half-duplex component 1245 may be configured as or otherwise support a means for dropping the sidelink data message based on the first priority value for the sidelink reference signal being greater than the second priority value for the sidelink data message.

In some examples, the transmission mode component 1250 may be configured as or otherwise support a means for activating a mode according to which the UE participates in the communication of the sidelink reference signal based on an absence of sidelink reference signal transmissions or receptions within the threshold time period of the sidelink reference signal transmission occasion.

In some examples, to support participating in the communication of the sidelink control information that schedules the sidelink data message, the sidelink data scheduling component 1230 may be configured as or otherwise support a means for receiving information indicating that the set of sidelink shared channel resources is for a retransmission of the sidelink data message, where participating in the communication of the sidelink reference signal via the sidelink reference signal transmission occasion is based on a successful reception of an initial transmission of the sidelink data message.

In some examples, participating in the communication of the sidelink control information includes receiving the sidelink control information that schedules the sidelink data message via the set of sidelink shared channel resources. In some examples, participating in the communication of the sidelink reference signal includes transmitting the sidelink reference signal via the sidelink reference signal transmission occasion and dropping a reception of the sidelink data message based on the comparison of the first priority value and the second priority value.

In some examples, the priority selection component 1255 may be configured as or otherwise support a means for selecting a highest priority value for the sidelink reference signal based on an absence of sidelink reference signal transmissions or receptions within the threshold time period of the sidelink reference signal transmission occasion, where participating in the communication of the sidelink reference signal is based on selecting the highest priority value for the sidelink reference signal.

In some examples, participating in the communication of the sidelink control information includes transmitting the sidelink control information that schedules the sidelink data message via the set of sidelink shared channel resources. In some examples, participating in the communication of the sidelink reference signal includes receiving the sidelink reference signal via the sidelink reference signal transmission occasion and dropping a transmission of the sidelink data message based on the comparison of the first priority value and the second priority value.

In some examples, the first priority value for the sidelink reference signal is based on a priority level of a second UE that transmits the sidelink reference signal, the second UE being a synchronization reference UE.

In some examples, the sidelink reference signal component 1235 may be configured as or otherwise support a means for transmitting, via a groupcast sidelink control information message, an indication of an absence of sidelink reference signal transmissions by the UE within the threshold time period of the sidelink reference signal transmission occasion, where participating in the communication of the sidelink reference signal including transmitting the sidelink reference signal based on transmitting the indication of the absence of the sidelink reference signal transmissions by the UE within the threshold time period of the sidelink reference signal transmission occasion.

In some examples, the indication of the absence of the sidelink reference signal transmissions by the UE within the threshold time period of the sidelink reference signal transmission occasion indicates, to a second UE, a request for the second UE to cancel a transmission of the sidelink data message via the set of sidelink shared channel resources.

In some examples, the sidelink reference signal component 1235 may be configured as or otherwise support a means for receiving, from a second UE via a groupcast sidelink control information message, an indication of an absence of sidelink reference signal transmissions by the second UE within the threshold time period of the sidelink reference signal transmission occasion, where participating in the communication of the sidelink reference signal including receiving the sidelink reference signal based on receiving the indication of the absence of the sidelink reference signal transmissions by the second UE within the threshold time period of the sidelink reference signal transmission occasion.

In some examples, the groupcast sidelink control information message includes a destination identifier of the second UE. In some examples, the UE identifies that the second UE has not transmitted the sidelink reference signal transmissions within the threshold time period of the sidelink reference signal transmission occasion in accordance with the destination identifier and the indication of the absence included in the groupcast sidelink control information message.

In some examples, the sidelink reference signal component 1235 may be configured as or otherwise support a means for transmitting, based on the first priority value for the sidelink reference signal being greater than the second priority value for the sidelink data message, a sidelink feedback message responsive to the sidelink control information, where the sidelink feedback message indicates a conflict between the sidelink reference signal and the sidelink data message, and where participating in the communication of the sidelink reference signal includes transmitting the sidelink reference signal based on indicating the conflict via the sidelink feedback message.

In some examples, the UE receives the sidelink control information from a second UE and transmits the sidelink feedback message to the second UE. In some examples, the sidelink feedback message indicating the conflict further indicates a request for the second UE to cancel a transmission of the sidelink data message via the set of sidelink shared channel resources.

In some examples, sidelink feedback messages indicating conflicts between sidelink reference signals and sidelink data messages are transmitted via a same set of sidelink feedback channel symbols, a same periodicity, and a same cyclic shift as sidelink feedback messages indicating feedback associated with sidelink data messages.

In some examples, sidelink feedback messages indicating conflicts between sidelink reference signals and sidelink data messages are transmitted via a first set of physical resource blocks and sidelink feedback messages indicating feedback associated with sidelink data messages are transmitted via a second set of physical resource blocks.

In some examples, the sidelink feedback message is transmitted via a sidelink feedback channel resource. In some examples, the sidelink feedback channel resource is associated with an index that is based on a source identifier of a second UE from which the UE receives the sidelink control information.

In some examples, to support participating in the communication of the sidelink control information, the sidelink data scheduling component 1230 may be configured as or otherwise support a means for receiving the sidelink control information that schedules the sidelink data message via the set of sidelink shared channel resources, where the sidelink control information includes information indicative of the second priority value of the sidelink data message.

In some examples, to support participating in the communication of the sidelink control information, the starting offset component 1260 may be configured as or otherwise support a means for selecting a starting offset, from a set of starting offsets, for the sidelink reference signal relative to a starting point of the sidelink reference signal transmission occasion in accordance with the first priority value for the sidelink reference signal. In some examples, to support participating in the communication of the sidelink control information, the cyclic prefix component 1265 may be configured as or otherwise support a means for applying a cyclic prefix extension to the sidelink reference signal, where a length of the cyclic prefix extension is based on the starting offset.

In some examples, a respective starting offset of the set of starting offsets corresponds to a respective priority value of a set of priority values. In some examples, the first priority value is associated with the starting offset and the second priority value is associated with a second starting offset.

In some examples, the sidelink reference signal includes an S-SSB.

Additionally, or alternatively, the communications manager 1220 may support wireless communication at a UE in accordance with examples as disclosed herein. In some examples, the candidate transmission occasions component 1225 may be configured as or otherwise support a means for receiving control signaling indicating a set of candidate sidelink reference signal transmission occasions, the set of candidate sidelink reference signal transmission occasions being included within a sidelink resource pool available for sidelink data messages. In some examples, the sidelink data scheduling component 1230 may be configured as or otherwise support a means for participating in communication of sidelink control information that schedules a sidelink data message via a set of sidelink shared channel resources from the sidelink resource pool, where the set of sidelink shared channel resources at least partially overlaps in time with a sidelink reference signal transmission occasion of the set of candidate sidelink reference signal transmission occasions. The sidelink data communication component 1240 may be configured as or otherwise support a means for participating in communication of the sidelink data message, via the set of sidelink shared channel resources, based on a comparison of a first priority value for a sidelink reference signal and a second priority value for the sidelink data message, where the first priority value for the sidelink reference signal is based on whether a sidelink reference signal transmission is performed within a threshold time period of the sidelink reference signal transmission occasion.

In some examples, the half-duplex component 1245 may be configured as or otherwise support a means for dropping the sidelink reference signal based on the first priority value for the sidelink reference signal being lower than the second priority value for the sidelink data message.

In some examples, the priority selection component 1255 may be configured as or otherwise support a means for selecting a lowest priority value for the sidelink reference signal in accordance with a presence of sidelink reference signal transmissions or receptions within the threshold time period of the sidelink reference signal transmission occasion, where participating in the communication of the sidelink data message is based on selecting the lowest priority value for the sidelink reference signal.

In some examples, to support participating in the communication of the sidelink control information that schedules the sidelink data message, the sidelink data scheduling component 1230 may be configured as or otherwise support a means for receiving information indicating that the set of sidelink shared channel resources is for a retransmission of the sidelink data message, where participating in the communication of the sidelink data message via the set of sidelink shared channel resources is based on an unsuccessful reception of an initial transmission of the sidelink data message.

In some examples, participating in the communication of the sidelink control information includes receiving the sidelink control information that schedules the sidelink data message via the set of sidelink shared channel resources. In some examples, participating in the communication of the sidelink data message includes receiving the sidelink data message via the set of sidelink shared channel resources and dropping a transmission of the sidelink reference signal based on the comparison of the first priority value and the second priority value.

In some examples, participating in the communication of the sidelink control information includes transmitting the sidelink control information that schedules the sidelink data message via the set of sidelink shared channel resources. In some examples, participating in the communication of the sidelink reference signal includes transmitting the sidelink data message via the set of sidelink shared channel resources and dropping a reception of the sidelink reference signal based on the comparison of the first priority value and the second priority value.

In some examples, the first priority value for the sidelink reference signal is based on a priority level of a second UE that transmits the sidelink reference signal, the second UE being a synchronization reference UE.

In some examples, the starting offset component 1260 may be configured as or otherwise support a means for selecting a starting offset, from a set of starting offsets, for the sidelink data message relative to a starting point of the sidelink reference signal transmission occasion in accordance with the second priority value for the sidelink data message. In some examples, the cyclic prefix component 1265 may be configured as or otherwise support a means for applying a cyclic prefix extension to the sidelink data message, where a length of the cyclic prefix extension is based on the starting offset.

In some examples, a respective starting offset of the set of starting offsets corresponds to a respective priority value of a set of priority values. In some examples, the second priority value is associated with the starting offset and the first priority value is associated with a second starting offset.

In some examples, the sidelink reference signal includes an S-SSB.

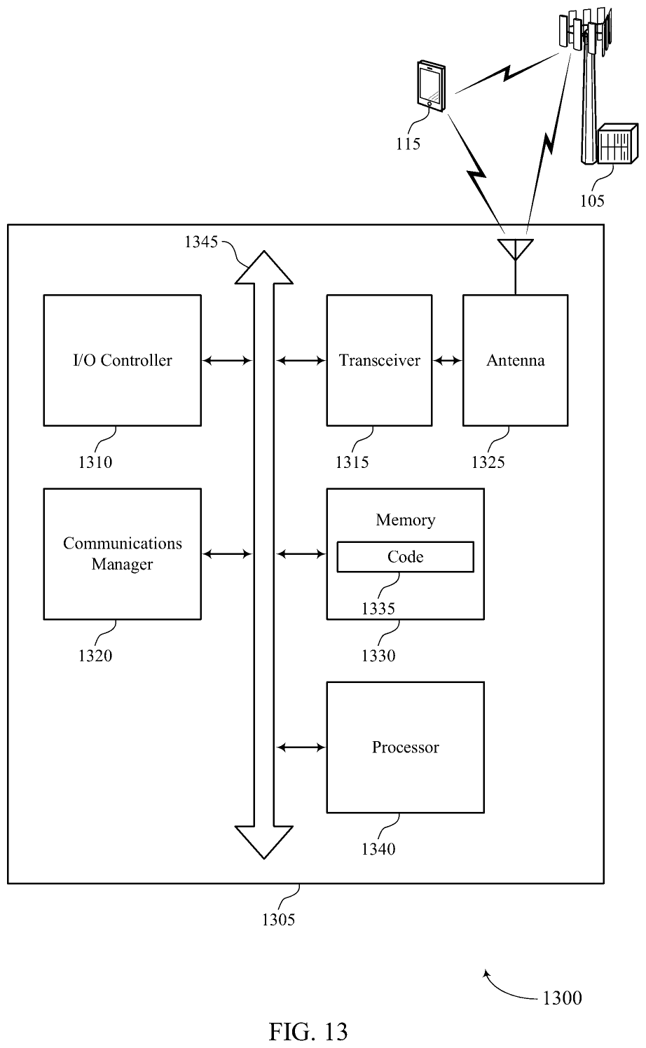

FIG. 13 illustrates a diagram of a system 1300 including a device 1305 that supports prioritization between sidelink reference signals and sidelink data messages in sidelink unlicensed deployments in accordance with one or more aspects of the present disclosure. The device 1305 may be an example of or include the components of a device 1005, a device 1105, or a UE 115 as described herein. The device 1305 may communicate (e.g., wirelessly) with one or more network entities 105, one or more UEs 115, or any combination thereof. The device 1305 may include components for bi-directional voice and data communications including components for transmitting and receiving communications, such as a communications manager 1320, an input/output (I/O) controller 1310, a transceiver 1315, an antenna 1325, a memory 1330, code 1335, and a processor 1340. These components may be in electronic communication or otherwise coupled (e.g., operatively, communicatively, functionally, electronically, electrically) via one or more buses (e.g., a bus 1345).

The I/O controller 1310 may manage input and output signals for the device 1305. The I/O controller 1310 may also manage peripherals not integrated into the device 1305. In some cases, the I/O controller 1310 may represent a physical connection (e.g., port) to an external peripheral. In some cases, the I/O controller 1310 may utilize an operating system such as iOS®, ANDROID®, MS-DOS®, MS-WINDOWS®, OS/2®, UNIX®, LINUX®, or another operating system. Additionally, or alternatively, the I/O controller 1310 may represent or interact with a modem, a keyboard, a mouse, a touchscreen, or a similar device. In some cases, the I/O controller 1310 may be implemented as part of a processor, such as the processor 1340. In some cases, a user may interact with the device 1305 via the I/O controller 1310 or via hardware components controlled by the I/O controller 1310.

The device 1305 may include one or more antennas 1325, which may be capable of transmitting or receiving multiple wireless transmissions (e.g., concurrently). The transceiver 1315 may support bi-directional communications via the one or more antennas 1325, wired interfaces, or wireless interfaces as described herein. For example, the transceiver 1315 may include a wireless transceiver and may communicate bi-directionally with another wireless transceiver. In some examples, the transceiver 1315 may include a modem to modulate signals, to provide the modulated signals for transmission (e.g., by one or more antennas 1325), to receive modulated signals (e.g., from one or more antennas 1325), and to demodulate signals. The transceiver 1315, or the transceiver 1315 and one or more antennas 1325, may be an example of a transmitter 1015, a transmitter 1115, a receiver 1010, a receiver 1110, or any combination thereof or component thereof, as described herein. In some examples, the transceiver 1315 may be operable to support communications via one or more communications links (e.g., a communication link 125, a communication link 135, a communication link 155).

The memory 1330 may include random access memory (RAM) and read-only memory (ROM). The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a basic I/O system (BIOS) which may control basic hardware or software operation such as the interaction with peripheral components or devices.

The processor 1340 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting prioritization between sidelink reference signals and sidelink data messages in sidelink unlicensed deployments). For example, the device 1305 or a component of the device 1305 may include a processor 1340 and memory 1330 coupled with the processor 1340, the processor 1340 and memory 1330 configured to perform various functions described herein.

The communications manager 1320 may support wireless communication at a UE in accordance with examples as disclosed herein. For example, the communications manager 1320 may be configured as or otherwise support a means for receiving control signaling indicating a set of candidate sidelink reference signal transmission occasions, the set of candidate sidelink reference signal transmission occasions being included within a sidelink resource pool available for sidelink data messages. The communications manager 1320 may be configured as or otherwise support a means for participating in communication of sidelink control information that schedules a sidelink data message via a set of sidelink shared channel resources from the sidelink resource pool. The communications manager 1320 may be configured as or otherwise support a means for participating in communication of a sidelink reference signal, via a sidelink reference signal transmission occasion of the set of candidate sidelink reference signal transmission occasions that at least partially overlaps in time with the set of sidelink shared channel resources, the participation in the communication of the sidelink reference signal based on a comparison of a first priority value for the sidelink reference signal and a second priority value for the sidelink data message, where the first priority value for the sidelink reference signal is based on whether a sidelink reference signal transmission is performed within a threshold time period of the sidelink reference signal transmission occasion.

Additionally, or alternatively, the communications manager 1320 may support wireless communication at a UE in accordance with examples as disclosed herein. For example, the communications manager 1320 may be configured as or otherwise support a means for receiving control signaling indicating a set of candidate sidelink reference signal transmission occasions, the set of candidate sidelink reference signal transmission occasions being included within a sidelink resource pool available for sidelink data messages. The communications manager 1320 may be configured as or otherwise support a means for participating in communication of sidelink control information that schedules a sidelink data message via a set of sidelink shared channel resources from the sidelink resource pool, where the set of sidelink shared channel resources at least partially overlaps in time with a sidelink reference signal transmission occasion of the set of candidate sidelink reference signal transmission occasions. The communications manager 1320 may be configured as or otherwise support a means for participating in communication of the sidelink data message, via the set of sidelink shared channel resources, based on a comparison of a first priority value for a sidelink reference signal and a second priority value for the sidelink data message, where the first priority value for the sidelink reference signal is based on whether a sidelink reference signal transmission is performed within a threshold time period of the sidelink reference signal transmission occasion.

By including or configuring the communications manager 1320 in accordance with examples as described herein, the device 1305 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1320 may be configured to perform various operations (e.g., receiving, obtaining, monitoring, outputting, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, the transceiver 1315, or any combination thereof. For example, the code 1335 may include instructions executable by the processor 1340 to cause the device 1305 to perform various aspects of prioritization between sidelink reference signals and sidelink data messages in sidelink unlicensed deployments as described herein, or the processor 1340 and the memory 1330 may be otherwise configured to perform or support such operations.

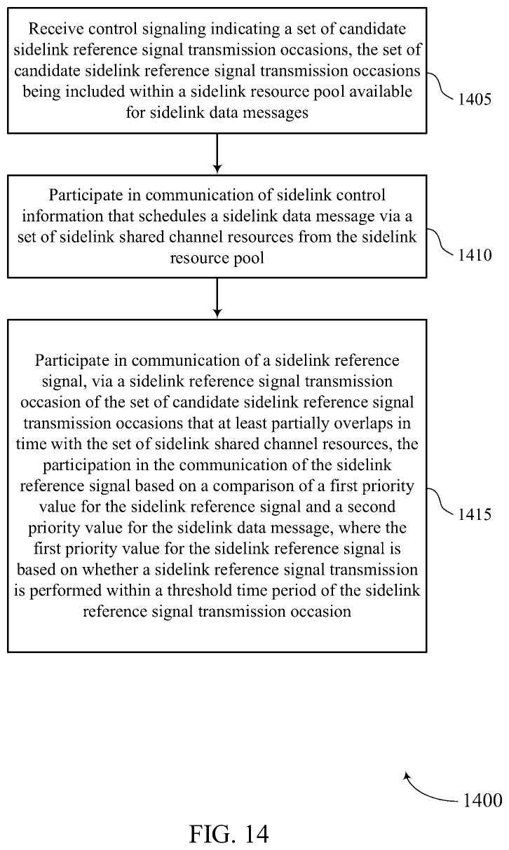

FIG. 14 illustrates a flowchart showing a method 1400 that supports prioritization between sidelink reference signals and sidelink data messages in sidelink unlicensed deployments in accordance with one or more aspects of the present disclosure. The operations of the method 1400 may be implemented by a UE or its components as described herein. For example, the operations of the method 1400 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1405, the method may include receiving control signaling indicating a set of candidate sidelink reference signal transmission occasions, the set of candidate sidelink reference signal transmission occasions being included within a sidelink resource pool available for sidelink data messages. The operations of 1405 may be performed in accordance with examples as disclosed herein. In some examples, aspects of the operations of 1405 may be performed by a candidate transmission occasions component 1225 as described with reference to FIG. 12.

At 1410, the method may include participating in communication of sidelink control information that schedules a sidelink data message via a set of sidelink shared channel resources from the sidelink resource pool. The operations of 1410 may be performed in accordance with examples as disclosed herein. In some examples, aspects of the operations of 1410 may be performed by a sidelink data scheduling component 1230 as described with reference to FIG. 12.

At 1415, the method may include participating in communication of a sidelink reference signal, via a sidelink reference signal transmission occasion of the set of candidate sidelink reference signal transmission occasions that at least partially overlaps in time with the set of sidelink shared channel resources, the participation in the communication of the sidelink reference signal based on a comparison of a first priority value for the sidelink reference signal and a second priority value for the sidelink data message, where the first priority value for the sidelink reference signal is based on whether a sidelink reference signal transmission is performed within a threshold time period of the sidelink reference signal transmission occasion. The operations of 1415 may be performed in accordance with examples as disclosed herein. In some examples, aspects of the operations of 1415 may be performed by a sidelink reference signal component 1235 as described with reference to FIG. 12.

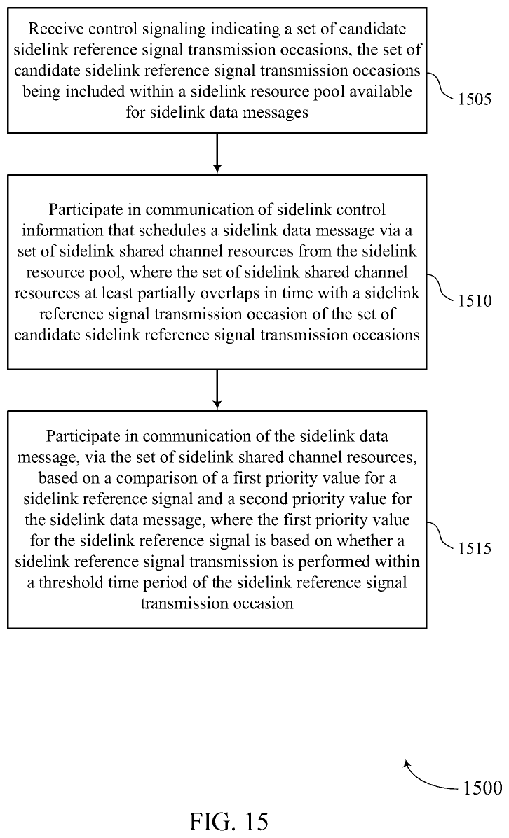

FIG. 15 illustrates a flowchart showing a method 1500 that supports prioritization between sidelink reference signals and sidelink data messages in sidelink unlicensed deployments in accordance with one or more aspects of the present disclosure. The operations of the method 1500 may be implemented by a UE or its components as described herein. For example, the operations of the method 1500 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1505, the method may include receiving control signaling indicating a set of candidate sidelink reference signal transmission occasions, the set of candidate sidelink reference signal transmission occasions being included within a sidelink resource pool available for sidelink data messages. The operations of 1505 may be performed in accordance with examples as disclosed herein. In some examples, aspects of the operations of 1505 may be performed by a candidate transmission occasions component 1225 as described with reference to FIG. 12.

At 1510, the method may include participating in communication of sidelink control information that schedules a sidelink data message via a set of sidelink shared channel resources from the sidelink resource pool, where the set of sidelink shared channel resources at least partially overlaps in time with a sidelink reference signal transmission occasion of the set of candidate sidelink reference signal transmission occasions. The operations of 1510 may be performed in accordance with examples as disclosed herein. In some examples, aspects of the operations of 1510 may be performed by a sidelink data scheduling component 1230 as described with reference to FIG. 12.

At 1515, the method may include participating in communication of the sidelink data message, via the set of sidelink shared channel resources, based on a comparison of a first priority value for a sidelink reference signal and a second priority value for the sidelink data message, where the first priority value for the sidelink reference signal is based on whether a sidelink reference signal transmission is performed within a threshold time period of the sidelink reference signal transmission occasion. The operations of 1515 may be performed in accordance with examples as disclosed herein. In some examples, aspects of the operations of 1515 may be performed by a sidelink data communication component 1240 as described with reference to FIG. 12.

The following provides an overview of aspects of the present disclosure:
Aspect 1: A method for wireless communication at a UE, comprising: receiving control signaling indicating a set of candidate sidelink reference signal transmission occasions, the set of candidate sidelink reference signal transmission occasions being included within a sidelink resource pool available for sidelink data messages: participating in communication of sidelink control information that schedules a sidelink data message via a set of sidelink shared channel resources from the sidelink resource pool; and participating in communication of a sidelink reference signal, via a sidelink reference signal transmission occasion of the set of candidate sidelink reference signal transmission occasions that at least partially overlaps in time with the set of sidelink shared channel resources, the participation in the communication of the sidelink reference signal based at least in part on a comparison of a first priority value for the sidelink reference signal and a second priority value for the sidelink data message, wherein the first priority value for the sidelink reference signal is based at least in part on whether a sidelink reference signal transmission is performed within a threshold time period of the sidelink reference signal transmission occasion.
Aspect 2: The method of aspect 1, further comprising: dropping the sidelink data message based at least in part on the first priority value for the sidelink reference signal being greater than the second priority value for the sidelink data message.
Aspect 3: The method of any of aspects 1 through 2, further comprising: activating a mode according to which the UE participates in the communication of the sidelink reference signal based at least in part on an absence of sidelink reference signal transmissions or receptions within the threshold time period of the sidelink reference signal transmission occasion.
Aspect 4: The method of any of aspects 1 through 3, wherein participating in the communication of the sidelink control information that schedules the sidelink data message further comprises: receiving information indicating that the set of sidelink shared channel resources is for a retransmission of the sidelink data message, wherein participating in the communication of the sidelink reference signal via the sidelink reference signal transmission occasion is based at least in part on a successful reception of an initial transmission of the sidelink data message.
Aspect 5: The method of any of aspects 1 through 4, wherein participating in the communication of the sidelink control information comprises receiving the sidelink control information that schedules the sidelink data message via the set of sidelink shared channel resources; and participating in the communication of the sidelink reference signal comprises transmitting the sidelink reference signal via the sidelink reference signal transmission occasion and dropping a reception of the sidelink data message based at least in part on the comparison of the first priority value and the second priority value.
Aspect 6: The method of any of aspects 1 through 5, further comprising: selecting a highest priority value for the sidelink reference signal based at least in part on an absence of sidelink reference signal transmissions or receptions within the threshold time period of the sidelink reference signal transmission occasion, wherein participating in the communication of the sidelink reference signal is based at least in part on selecting the highest priority value for the sidelink reference signal.
Aspect 7: The method of any of aspects 1 through 3 and 6, wherein participating in the communication of the sidelink control information comprises transmitting the sidelink control information that schedules the sidelink data message via the set of sidelink shared channel resources; and participating in the communication of the sidelink reference signal comprises receiving the sidelink reference signal via the sidelink reference signal transmission occasion and dropping a transmission of the sidelink data message based at least in part on the comparison of the first priority value and the second priority value.
Aspect 8: The method of any of aspects 1 through 7, wherein the first priority value for the sidelink reference signal is based at least in part on a priority level of a second UE that transmits the sidelink reference signal, the second UE being a synchronization reference UE.
Aspect 9: The method of any of aspects 1 through 8, further comprising: transmitting, via a groupcast sidelink control information message, an indication of an absence of sidelink reference signal transmissions by the UE within the threshold time period of the sidelink reference signal transmission occasion, wherein participating in the communication of the sidelink reference signal comprises transmitting the sidelink reference signal based at least in part on transmitting the indication of the absence of the sidelink reference signal transmissions by the UE within the threshold time period of the sidelink reference signal transmission occasion.
Aspect 10: The method of aspect 9, wherein the indication of the absence of the sidelink reference signal transmissions by the UE within the threshold time period of the sidelink reference signal transmission occasion indicates, to a second UE, a request for the second UE to cancel a transmission of the sidelink data message via the set of sidelink shared channel resources.
Aspect 11: The method of any of aspects 1 through 10, further comprising: receiving, from a second UE via a groupcast sidelink control information message, an indication of an absence of sidelink reference signal transmissions by the second UE within the threshold time period of the sidelink reference signal transmission occasion, wherein participating in the communication of the sidelink reference signal comprises receiving the sidelink reference signal based at least in part on receiving the indication of the absence of the sidelink reference signal transmissions by the second UE within the threshold time period of the sidelink reference signal transmission occasion.
Aspect 12: The method of aspect 11, wherein the groupcast sidelink control information message includes a destination identifier of the second UE, and the UE identifies that the second UE has not transmitted the sidelink reference signal transmissions within the threshold time period of the sidelink reference signal transmission occasion in accordance with the destination identifier and the indication of the absence included in the groupcast sidelink control information message.
Aspect 13: The method of any of aspects 1 through 12, further comprising: transmitting, based at least in part on the first priority value for the sidelink reference signal being greater than the second priority value for the sidelink data message, a sidelink feedback message responsive to the sidelink control information, wherein the sidelink feedback message indicates a conflict between the sidelink reference signal and the sidelink data message, and wherein participating in the communication of the sidelink reference signal comprises transmitting the sidelink reference signal based at least in part on indicating the conflict via the sidelink feedback message.
Aspect 14: The method of aspect 13, wherein the UE receives the sidelink control information from a second UE and transmits the sidelink feedback message to the second UE, and the sidelink feedback message indicating the conflict further indicates a request for the second UE to cancel a transmission of the sidelink data message via the set of sidelink shared channel resources.
Aspect 15: The method of any of aspects 13 through 14, wherein sidelink feedback messages indicating conflicts between sidelink reference signals and sidelink data messages are transmitted via a same set of sidelink feedback channel symbols, a same periodicity, and a same cyclic shift as sidelink feedback messages indicating feedback associated with sidelink data messages.
Aspect 16: The method of any of aspects 13 through 15, wherein sidelink feedback messages indicating conflicts between sidelink reference signals and sidelink data messages are transmitted via a first set of physical resource blocks and sidelink feedback messages indicating feedback associated with sidelink data messages are transmitted via a second set of physical resource blocks.
Aspect 17: The method of any of aspects 13 through 16, wherein the sidelink feedback message is transmitted via a sidelink feedback channel resource, and the sidelink feedback channel resource is associated with an index that is based at least in part on a source identifier of a second UE from which the UE receives the sidelink control information.
Aspect 18: The method of any of aspects 1 through 6 and 8 through 17, wherein participating in the communication of the sidelink control information comprises: receiving the sidelink control information that schedules the sidelink data message via the set of sidelink shared channel resources, wherein the sidelink control information includes information indicative of the second priority value of the sidelink data message.
Aspect 19: The method of any of aspects 1 through 18, wherein participating in the communication of the sidelink control information comprises: selecting a starting offset, from a set of starting offsets, for the sidelink reference signal relative to a starting point of the sidelink reference signal transmission occasion in accordance with the first priority value for the sidelink reference signal; and applying a cyclic prefix extension to the sidelink reference signal, wherein a length of the cyclic prefix extension is based at least in part on the starting offset.
Aspect 20: The method of aspect 19, wherein a respective starting offset of the set of starting offsets corresponds to a respective priority value of a set of priority values, the first priority value is associated with the starting offset and the second priority value is associated with a second starting offset.
Aspect 21: The method of any of aspects 1 through 20, wherein the sidelink reference signal comprises an S-SSB.
Aspect 22: A method for wireless communication at a UE, comprising: receiving control signaling indicating a set of candidate sidelink reference signal transmission occasions, the set of candidate sidelink reference signal transmission occasions being included within a sidelink resource pool available for sidelink data messages: participating in communication of sidelink control information that schedules a sidelink data message via a set of sidelink shared channel resources from the sidelink resource pool, wherein the set of sidelink shared channel resources at least partially overlaps in time with a sidelink reference signal transmission occasion of the set of candidate sidelink reference signal transmission occasions; and participating in communication of the sidelink data message, via the set of sidelink shared channel resources, based at least in part on a comparison of a first priority value for a sidelink reference signal and a second priority value for the sidelink data message, wherein the first priority value for the sidelink reference signal is based at least in part on whether a sidelink reference signal transmission is performed within a threshold time period of the sidelink reference signal transmission occasion.
Aspect 23: The method of aspect 22, further comprising: dropping the sidelink reference signal based at least in part on the first priority value for the sidelink reference signal being lower than the second priority value for the sidelink data message.
Aspect 24: The method of any of aspects 22 through 23, further comprising: selecting a lowest priority value for the sidelink reference signal in accordance with a presence of sidelink reference signal transmissions or receptions within the threshold time period of the sidelink reference signal transmission occasion, wherein participating in the communication of the sidelink data message is based at least in part on selecting the lowest priority value for the sidelink reference signal.
Aspect 25: The method of any of aspects 22 through 24, wherein participating in the communication of the sidelink control information that schedules the sidelink data message further comprises: receiving information indicating that the set of sidelink shared channel resources is for a retransmission of the sidelink data message, wherein participating in the communication of the sidelink data message via the set of sidelink shared channel resources is based at least in part on an unsuccessful reception of an initial transmission of the sidelink data message.
Aspect 26: The method of any of aspects 22 through 25, wherein participating in the communication of the sidelink control information comprises receiving the sidelink control information that schedules the sidelink data message via the set of sidelink shared channel resources; and participating in the communication of the sidelink data message comprises receiving the sidelink data message via the set of sidelink shared channel resources and dropping a transmission of the sidelink reference signal based at least in part on the comparison of the first priority value and the second priority value.
Aspect 27: The method of any of aspects 22 through 24, wherein participating in the communication of the sidelink control information comprises transmitting the sidelink control information that schedules the sidelink data message via the set of sidelink shared channel resources; and participating in the communication of the sidelink reference signal comprises transmitting the sidelink data message via the set of sidelink shared channel resources and dropping a reception of the sidelink reference signal based at least in part on the comparison of the first priority value and the second priority value.
Aspect 28: The method of any of aspects 22 through 26, wherein the first priority value for the sidelink reference signal is based at least in part on a priority level of a second UE that transmits the sidelink reference signal, the second UE being a synchronization reference UE.
Aspect 29: The method of any of aspects 22 through 28, further comprising: selecting a starting offset, from a set of starting offsets, for the sidelink data message relative to a starting point of the sidelink reference signal transmission occasion in accordance with the second priority value for the sidelink data message; and applying a cyclic prefix extension to the sidelink data message, wherein a length of the cyclic prefix extension is based at least in part on the starting offset.
Aspect 30: The method of aspect 29, wherein a respective starting offset of the set of starting offsets corresponds to a respective priority value of a set of priority values, the second priority value is associated with the starting offset and the first priority value is associated with a second starting offset.
Aspect 31: The method of any of aspects 22 through 30, wherein the sidelink reference signal comprises an S-SSB.
Aspect 32: An apparatus for wireless communication at a UE, comprising a processor: memory coupled with the processor; and instructions stored in the memory and executable by the processor to cause the apparatus to perform a method of any of aspects 1 through 21.
Aspect 33: An apparatus for wireless communication at a UE, comprising at least one means for performing a method of any of aspects 1 through 21.
Aspect 34: A non-transitory computer-readable medium storing code for wireless communication at a UE, the code comprising instructions executable by a processor to perform a method of any of aspects 1 through 21.
Aspect 35: An apparatus for wireless communication at a UE, comprising a processor: memory coupled with the processor; and instructions stored in the memory and executable by the processor to cause the apparatus to perform a method of any of aspects 22 through 31.
Aspect 36: An apparatus for wireless communication at a UE, comprising at least one means for performing a method of any of aspects 22 through 31.
Aspect 37: A non-transitory computer-readable medium storing code for wireless communication at a UE, the code comprising instructions executable by a processor to perform a method of any of aspects 22 through 31.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a user equipment (UE), comprising:
a processor;
memory coupled with the processor; and
instructions stored in the memory and executable by the processor to cause the apparatus to:
receive control signaling indicating a set of candidate sidelink reference signal transmission occasions, the set of candidate sidelink reference signal transmission occasions being included within a sidelink resource pool available for sidelink data messages;
participate in communication of sidelink control information that schedules a sidelink data message via a set of sidelink shared channel resources from the sidelink resource pool; and
participate in communication of a sidelink reference signal, via a sidelink reference signal transmission occasion of the set of candidate sidelink reference signal transmission occasions that at least partially overlaps in time with the set of sidelink shared channel resources, the participation in the communication of the sidelink reference signal based at least in part on a comparison of a first priority value for the sidelink reference signal and a second priority value for the sidelink data message, wherein the first priority value for the sidelink reference signal is based at least in part on whether a sidelink reference signal transmission is performed within a threshold time period of the sidelink reference signal transmission occasion.

2. The apparatus of claim 1, wherein the instructions are further executable by the processor to cause the apparatus to:
drop the sidelink data message based at least in part on the first priority value for the sidelink reference signal being greater than the second priority value for the sidelink data message.

3. The apparatus of claim 1, wherein the instructions are further executable by the processor to cause the apparatus to:
activate a mode according to which the UE participates in the communication of the sidelink reference signal based at least in part on an absence of sidelink reference signal transmissions or receptions within the threshold time period of the sidelink reference signal transmission occasion.

4. The apparatus of claim 1, wherein the instructions to participate in the communication of the sidelink control information that schedules the sidelink data message are further executable by the processor to cause the apparatus to:
receive information indicating that the set of sidelink shared channel resources is for a retransmission of the sidelink data message, wherein participating in the communication of the sidelink reference signal via the sidelink reference signal transmission occasion is based at least in part on a successful reception of an initial transmission of the sidelink data message.

5. The apparatus of claim 1, wherein:
the instructions to participate in the communication of the sidelink control information are further executable by the processor to cause the apparatus to receive the sidelink control information that schedules the sidelink data message via the set of sidelink shared channel resources; and
the instructions to participate in the communication of the sidelink reference signal are further executable by the processor to cause the apparatus to transmit the sidelink reference signal via the sidelink reference signal transmission occasion and dropping a reception of the sidelink data message based at least in part on the comparison of the first priority value and the second priority value.

6. The apparatus of claim 1, wherein the instructions are further executable by the processor to cause the apparatus to:
select a highest priority value for the sidelink reference signal based at least in part on an absence of sidelink reference signal transmissions or receptions within the threshold time period of the sidelink reference signal transmission occasion, wherein participating in the communication of the sidelink reference signal is based at least in part on selecting the highest priority value for the sidelink reference signal.

7. The apparatus of claim 1, wherein:
the instructions to participate in the communication of the sidelink control information are further executable by the processor to cause the apparatus to transmit the sidelink control information that schedules the sidelink data message via the set of sidelink shared channel resources; and
the instructions to participate in the communication of the sidelink reference signal are further executable by the processor to cause the apparatus to receive the sidelink reference signal via the sidelink reference signal transmission occasion and dropping a transmission of the sidelink data message based at least in part on the comparison of the first priority value and the second priority value.

8. The apparatus of claim 1, wherein the first priority value for the sidelink reference signal is based at least in part on a priority level of a second UE that transmits the sidelink reference signal, the second UE being a synchronization reference UE.

9. The apparatus of claim 1, wherein the instructions are further executable by the processor to cause the apparatus to:
transmit, via a groupcast sidelink control information message, an indication of an absence of sidelink reference signal transmissions by the UE within the threshold time period of the sidelink reference signal transmission occasion, wherein participating in the communication of the sidelink reference signal comprises transmitting the sidelink reference signal based at least in part on transmitting the indication of the absence of the sidelink reference signal transmissions by the UE within the threshold time period of the sidelink reference signal transmission occasion.

10. The apparatus of claim 9, wherein the indication of the absence of the sidelink reference signal transmissions by the UE within the threshold time period of the sidelink reference signal transmission occasion indicates, to a second UE, a request for the second UE to cancel a transmission of the sidelink data message via the set of sidelink shared channel resources.

11-12. (canceled)

13. The apparatus of claim 1, wherein the instructions are further executable by the processor to cause the apparatus to:
transmit, based at least in part on the first priority value for the sidelink reference signal being greater than the second priority value for the sidelink data message, a sidelink feedback message responsive to the sidelink control information, wherein the sidelink feedback message indicates a conflict between the sidelink reference signal and the sidelink data message, and wherein participating in the communication of the sidelink reference signal comprises transmitting the sidelink reference signal based at least in part on indicating the conflict via the sidelink feedback message.

14-17. (canceled)

18. The apparatus of claim 1, wherein the instructions to participate in the communication of the sidelink control information are executable by the processor to cause the apparatus to:
receive the sidelink control information that schedules the sidelink data message via the set of sidelink shared channel resources, wherein the sidelink control information includes information indicative of the second priority value of the sidelink data message.

19. The apparatus of claim 1, wherein the instructions to participate in the communication of the sidelink control information are executable by the processor to cause the apparatus to:
select a starting offset, from a set of starting offsets, for the sidelink reference signal relative to a starting point of the sidelink reference signal transmission occasion in accordance with the first priority value for the sidelink reference signal; and
apply a cyclic prefix extension to the sidelink reference signal, wherein a length of the cyclic prefix extension is based at least in part on the starting offset.

20. (canceled)

21. The apparatus of claim 1, wherein the sidelink reference signal comprises a sidelink synchronization signal block.

22. An apparatus for wireless communication at a user equipment (UE), comprising:
a processor;
memory coupled with the processor; and
instructions stored in the memory and executable by the processor to cause the apparatus to:
receive control signaling indicating a set of candidate sidelink reference signal transmission occasions, the set of candidate sidelink reference signal transmission occasions being included within a sidelink resource pool available for sidelink data messages,
participate in communication of sidelink control information that schedules a sidelink data message via a set of sidelink shared channel resources from the sidelink resource pool, wherein the set of sidelink shared channel resources at least partially overlaps in time with a sidelink reference signal transmission occasion of the set of candidate sidelink reference signal transmission occasions; and
participate in communication of the sidelink data message, via the set of sidelink shared channel resources, based at least in part on a comparison of a first priority value for a sidelink reference signal and a second priority value for the sidelink data message, wherein the first priority value for the sidelink reference signal is based at least in part on whether a sidelink reference signal transmission is performed within a threshold time period of the sidelink reference signal transmission occasion.

23. The apparatus of claim 22, wherein the instructions are further executable by the processor to cause the apparatus to:
select a lowest priority value for the sidelink reference signal in accordance with a presence of sidelink reference signal transmissions or receptions within the threshold time period of the sidelink reference signal transmission occasion, wherein participating in the communication of the sidelink data message is based at least in part on selecting the lowest priority value for the sidelink reference signal.

24. The apparatus of claim 22, wherein the instructions to participate in the communication of the sidelink control information that schedules the sidelink data message are further executable by the processor to cause the apparatus to:
receive information indicating that the set of sidelink shared channel resources is for a retransmission of the sidelink data message, wherein participating in the communication of the sidelink data message via the set of sidelink shared channel resources is based at least in part on an unsuccessful reception of an initial transmission of the sidelink data message.

25. The apparatus of claim 22, wherein:
the instructions to participate in the communication of the sidelink control information are further executable by the processor to cause the apparatus to receive the sidelink control information that schedules the sidelink data message via the set of sidelink shared channel resources; and
the instructions to participate in the communication of the sidelink data message are further executable by the processor to cause the apparatus to receive the sidelink data message via the set of sidelink shared channel resources and drop a transmission of the sidelink reference signal based at least in part on the comparison of the first priority value and the second priority value.

26. The apparatus of claim 22, wherein:
the instructions to participate in the communication of the sidelink control information are further executable by the processor to cause the apparatus to transmit the sidelink control information that schedules the sidelink data message via the set of sidelink shared channel resources; and
the instructions to participate in the communication of the sidelink data message are further executable by the processor to cause the apparatus to transmit the sidelink data message via the set of sidelink shared channel resources and drop a reception of the sidelink reference signal based at least in part on the comparison of the first priority value and the second priority value.

27-28. (canceled)

29. A method for wireless communication at a user equipment (UE), comprising:
receiving control signaling indicating a set of candidate sidelink reference signal transmission occasions, the set of candidate sidelink reference signal transmission occasions being included within a sidelink resource pool available for sidelink data messages;
participating in communication of sidelink control information that schedules a sidelink data message via a set of sidelink shared channel resources from the sidelink resource pool; and
participating in communication of a sidelink reference signal, via a sidelink reference signal transmission occasion of the set of candidate sidelink reference signal transmission occasions that at least partially overlaps in time with the set of sidelink shared channel resources, the participation in the communication of the sidelink reference signal based at least in part on a comparison of a first priority value for the sidelink reference signal and a second priority value for the sidelink data message, wherein the first priority value for the sidelink reference signal is based at least in part on whether a sidelink reference signal transmission is performed within a threshold time period of the sidelink reference signal transmission occasion.

30. (canceled)
